(19) United States
(12) Patent Application Publication
(10) Pub. No.: US 2008/0075172 A1
(43) Pub. Date: Mar. 27, 2008

(54) MOTION PICTURE ENCODING APPARATUS AND METHOD

(75) Inventor: Shinichiro Koto, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/856,479

(22) Filed: Sep. 17, 2007

(30) Foreign Application Priority Data
Sep. 25, 2006 (JP) 2006-259781
Aug. 22, 2007 (JP) 2007-215811

(51) Int. Cl. H04N 7/26

(52) U.S. Cl. 375/240.24; 375/E07.2

(57) ABSTRACT

A first division unit divides the motion picture into a plurality of segments. A second division unit divides each segment into a plurality of picture groups each including a plurality of frames. The last picture group of each segment includes frames of a fixed predetermined number. An encoder determines timing information of decoding and display of each picture group based on timing information of a head frame of a previous picture group in each segment, and generates encoded data of each segment. The encoded data includes the timing information of each picture group. A connection unit connects the encoded data of the plurality of segments.

### CROSS-REFERENCE TO RELATED APPLICATIONS

This application is based upon and claims the benefit of priority from prior Japanese Patent Application No. 2006-259781, filed on Sep. 25, 2006, and prior Japanese Patent Application No. 2007-215811, filed on Aug. 22, 2007; the entire contents of which are incorporated herein by reference.

### FIELD OF THE INVENTION

The present invention relates to a motion picture encoding apparatus and a method for parallely encoding a plurality of segments of temporally divided picture data.

### BACKGROUND OF THE INVENTION

Picture encoding may be based on an International Standardization for video encoding, such as MPEG-2, MPEG-4, ITU-T Rec.H.264|ISO/IEC14496-10 MPEG-4AVC (Hereinafter, it is called “H.264”). A plurality of methods may be used to quickly encode picture data using a plurality of processors or hardware in parallel.

A representative parallel-encoding method is disclosed in JP-A No. 11-252544 (reference 1). A spatial division method and a temporal division method are disclosed. In the spatial division method, each frame is divided into a plurality of regions, and each region is encoded in parallel. In the temporal division method, picture data (motion picture) is divided into a plurality of segments (each segment having a plurality of frames), and each segment is encoded in parallel.

In the spatial division method, delay for encoding is low. However, processing amount of each region varies by difference of encoding difficulty among each region in an original picture. Usually, encoding process in synchronization with each frame is necessary. Accordingly, equalizing the load of each region is difficult, and quick encoding matched with parallel degree is also difficult. Furthermore, encoding based on correlation in the original picture is limitedly used in each region. Accordingly, encoding efficiency falls.

On the other hand, in the temporal division method, by excluding dependency between each segment, each segment is encoded in parallel so that connected segments can be continuously played back.

As shown in JP-A No. 2001-54115 (reference 2) or JP No. 3529599 (reference 3), encoded data of each segment should satisfy the following three conditions at a segmentation point.

(1) Connectivity of occupancy in a virtual buffer

(2) Continuity of field phase

(3) Prohibition of inter-frame prediction

As to (1), as shown in the reference 3, encoded bit amount of several frames neighboring the segmentation point is controlled so that the occupancy in the virtual buffer is a predetermined level at the segmentation point. As a result, encoded data of each segment can be continually connected.

As to (2), a field phase of the end frame (of the first segment) and the start frame (of the second segment) each neighboring the segmentation point is controlled as a predetermined value. As a result, encoded data of each segment can be continually connected.

As to (3), as shown in the reference 3, inter-frame prediction is limited in each segment, and inter-frame prediction over segments is prohibited. In general, encoding efficiency falls by prohibiting inter-frame prediction. In this case, by increasing a number of frames (to be continually encoded) in each segment, falling of encoding efficiency is suppressed. By increasing the number of frames in each segment, encoding delay generally increases. However, in case of encoding motion picture signals recorded in storage medium randomly accessible (such as a hard disk), delay of temporal division-encoding does not occur. Furthermore, as shown in the references 2 and 3, the temporal division method is suitable for partial-reencoding, or cut and paste video editing of encoded data.

As mentioned-above, in case of parallel-encoding picture signal recorded in the storage medium or in case of partially re-encoding or cut and paste video editing of encoded data after encoding, the temporal division method is effective. In an encoding method such as MPEG-2, at an end frame of each segment, occupancy of the virtual buffer, the field phase, and prohibition of inter-frame prediction are controlled. In this case, by connecting encoded data of each segment, connected segments can be continuously played back.

On the other hand, in a motion picture encoding method such as H.264, timing information of decoding and display of each encoded picture is included in motion picture encoded data. Accordingly, in the temporal division method, the connected segments cannot be guaranteed to be played back continuously. In H.264, each segment is divided into a plurality of groups of pictures. In case of encoding timing information to decode a first encoded picture in each group, a period from decoding timing of a first encoded picture in a previous group to decoding timing of a first encoded picture in a present group is encoded. In case of encoding timing information to decode each encoded picture except for the first encoded picture in each group, a period from decoding timing of the first encoded picture in the present group to decoding timing of each encoded picture in the present group is encoded. Furthermore, in case of encoding timing information to display each encoded picture in each group, a period from decoding timing to display timing of the encoded frame is encoded. Briefly, (decoding and display) timing information is encoded as a difference from past timing information. Accordingly, motion picture group should be encoded in order of input picture group.

In this encoding method, even if each segment (having a plurality of pictures) is encoded in parallel by controlling the occupancy of the virtual buffer, the field phase and the prohibit of inter-frame prediction, connected segments (all encoded pictures connected) cannot be guaranteed to be played back continuously, or the connected segments cannot be guaranteed to be edited (cut and paste) over segments. Because timing information to decode and display each picture may be discontinuous between a last picture of a previous segment and a first picture of a present segment.

### SUMMARY OF THE INVENTION

The present invention is directed to a motion picture encoding apparatus and a method for seamlessly parallel-encoding a plurality of segments temporally divided from picture data.

According to an aspect of the present invention, there is provided an apparatus for encoding a motion picture, comprising: a first division unit configured to divide the motion picture into a plurality of segments; a second division unit configured to divide each segment into a plurality of picture groups each including a plurality of frames, the last picture group of each segment including frames of a fixed predetermined number; an encoder configured to determine timing information of decoding and display of each picture group based on timing information of a head frame of a previous picture group in each segment, and to generate encoded data of each segment, the encoded data including the timing information of each picture group; and a connection unit configured to connect the encoded data of the plurality of segments.

According to another aspect of the present invention, there is also provided a method for encoding a motion picture, comprising: dividing the motion picture into a plurality of segments; dividing each segment into a plurality of picture groups each including a plurality of frames, the last picture group of each segment including frames of a fixed predetermined number; determining timing information of decoding and display of each picture group based on timing information of a head frame of a previous picture group in each segment; generating encoded data of each segment, the encoded data including the timing information of each picture group; and connecting the encoded data of the plurality of segments.

According to still another aspect of the present invention, there is also provided a computer readable medium storing program codes for causing a computer to encode a motion picture, the program codes comprising: a first program code to divide the motion picture into a plurality of segments; a second program code to divide each segment into a plurality of picture groups each including a plurality of frames, the last picture group of each segment including frames of a fixed predetermined number; a third program code to determine timing information of decoding and display of each picture group based on timing information of a head frame of a previous picture group in each segment; a fourth program code to generate encoded data of each segment, the encoded data including the timing information of each picture group; and a fifth program code to connect the encoded data of the plurality of segments.

### BRIEF DESCRIPTION OF THE DRAWINGS

FIG. 1 is a flow chart of processing of a motion picture encoding method according to one embodiment of the present invention.

FIG. 2 is a schematic diagram of data structure of motion picture encoded data.

FIG. 3 is one example of a Buffering Period SEI in motion picture encoded data.

FIG. 4 is one example of a Picture Timing SEI in motion picture encoded data.

FIG. 5 is a timing chart of each frame between motion picture encoded data and motion picture decoded data.

FIG. 6 is a flow chart of segment encoding processing in FIG. 1.

FIG. 7 is a flow chart of a first method of BP-division processing in FIG. 1.

FIG. 8 is a flow chart of a second method of BP-division processing in FIG. 1.

FIG. 9 is a flow chart of a third method of BP-division processing in FIG. 1.

FIG. 10 is a flow chart of a fourth method of BP-division processing in FIG. 1.

FIGS. 11A, 11B, and 11C are schematic diagrams of BP-length control of segment.

FIGS. 12A and 12B are schematic diagrams of BP-length control of segment in case of setting scene change or chapter point.

FIGS. 13A and 13B are schematic diagrams of BP-length control of segment in case of multi-story encoding.

FIG. 14 is a schematic diagram of fields of 3:2 pull-down.

FIGS. 15A, 15B, and 15C are schematic diagrams of phase control of encoding field.

FIGS. 16A1˜D1, 16A2˜D2 and 16A3˜D3 are schematic diagrams of another phase control of encoding field.

FIG. 17 is a block diagram of a first component of a motion picture encoding apparatus according to one embodiment.

FIG. 18 is a block diagram of a second component of the motion picture encoding apparatus according to one embodiment.

FIG. 19 is a block diagram of a third component of the motion picture encoding apparatus according to one embodiment.

FIG. 20 is a schematic diagram of a correction table of 3:2 pull-down pattern.

FIG. 21 is a schematic diagram of BP-length correction according to a first BP-length control method.

FIG. 22 is a schematic diagram of BP-length correction according to a second BP-length control method.

FIG. 23 is a flow chart of BP-length correction processing according to the first BP-length control method.

FIG. 24 is a flow chart of BP-length correction processing according to the second BP-length control method.

FIG. 25 is a schematic diagram of BP-length correction according to a third BP-length control method.

FIG. 26 is a flow chart of BP-length correction processing according to the third BP-length control method.

FIG. 27 is another flow chart of BP-length correction processing according to the third BP-length control method.

FIG. 28 is a schematic diagram of BP-length correction according to a fourth BP-length control method.

FIG. 29 is a flow chart of BP-length correction processing according to the fourth BP-length control method.

FIGS. 30A, 30B and 30C are schematic diagrams of BP-length correction according to two pass encoding method of a second embodiment.

FIGS. 31A, 31B and 31C are schematic diagrams of BP-length correction according to another two pass encoding method of the second embodiment.

FIG. 32 is a flow chart of two pass encoding processing according to the prior art.

FIG. 33 is a flow chart of two pass encoding processing according to the second embodiment.

FIG. 34 is a flow chart of another two pass encoding processing according to the second embodiment.

### DETAILED DESCRIPTION OF THE EMBODIMENTS

Hereinafter, various embodiments of the present invention will be explained by referring to the drawings. The present invention is not limited to the following embodiments.

[1] Processing of a Motion Picture Encoding Method:

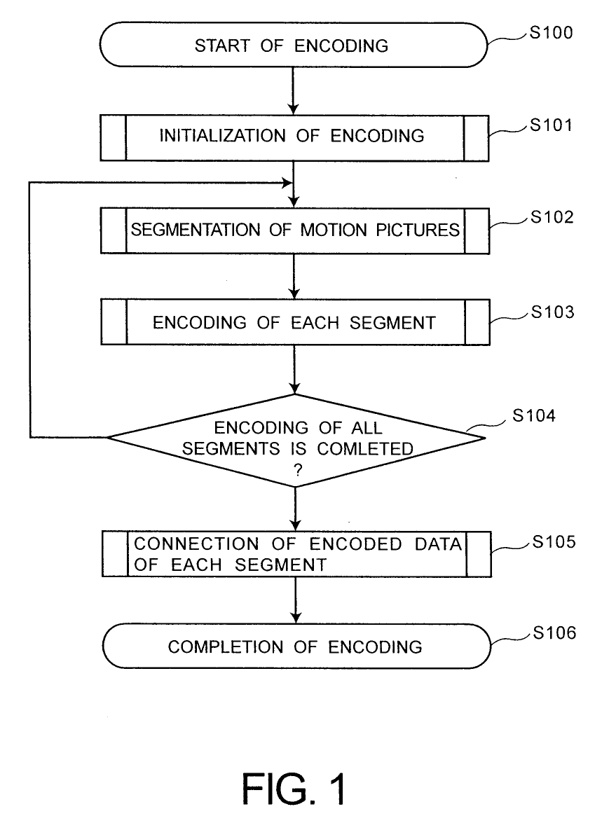

FIG. 1 is a flow chart of processing of a motion picture encoding method according to the first embodiment of the present invention. At the start of encoding (S100), encoding parameter such as bit rate is set as initialization processing (S101). Next, a motion picture sequence to be encoded is temporarily divided into a plurality of segments (S102). Each segment comprises a plurality of continuous frames. Next, each segment is encoded in order (S103). In case of using one encoder, each segment is sequentially encoded. In case of using a plurality of encoders, each segment is independently encoded in parallel.

When encoding of all segments is completed (S104), encoded data of each segment is connected (S105). As a result, encoded data of the plurality of segments continuously playable back are output, and encoding processing is completed (S106).

As mentioned-above, the motion picture sequence is temporarily divided into a plurality of segments, and each segment is independently encoded in parallel. Accordingly, quick encoding is possible in proportion to parallel degree, and encoded data of each segment does not depend on parallel degree.

In the first embodiment, in order to seamlessly play back connected segments as the motion picture sequence, encoded data of each segment (temporarily divided from the motion picture) is connected. In this case, in the same way with limitation of connection point of encoded data (disclosed in the reference 1), the following controls (1)˜(3) are executed for each segment.

(1) Prohibition of inter-frame prediction over a segmentation delimiter (Closed GOP)

(2) Occupancy of a virtual buffer for an end point (neighboring the segment delimiter) of each segment is above a predetermined value.

(3) A display field phase of a start point of each segment and a display field phase of an end point of the previous segment are respectively predetermined.

Furthermore, in addition to above control (1)˜(3), in order to equalize a number of frames of a last picture group of each segment, division control of picture group is executed as explained afterwards.

[2] Constraint Condition of Segment Delimiter:

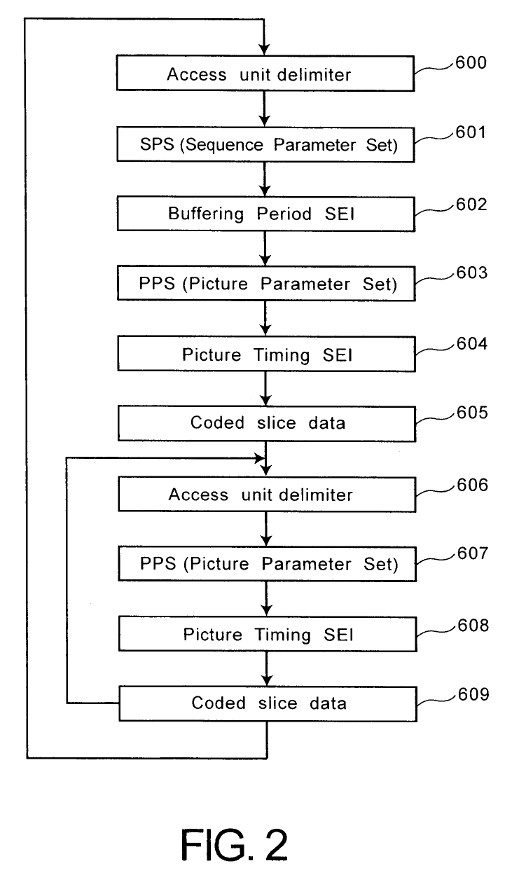

Hereinafter, constraint condition of segment delimiter is explained using the motion picture encoding method “H.264” as an example. FIG. 2 is a typical component of encoded data structure of each picture group (divided from a segment) in H.264.

First, Access unit delimiter (600) representing a delimiter (a boundary) of a picture is encoded. Next, Sequence Parameter Set (601) representing encoding parameter of the picture group, and Buffering Period SEI (602) representing timing information of buffering delay for a decoder side are encoded.

Next, Picture Parameter Set (603), representing encoding parameter of each picture, and Picture Timing SEI (604), representing encoding timing and display timing of each picture, are encoded. Continually, Coded Slice data (605) as data contents of the motion picture is encoded.

Next, as to each frame in the picture group, Access unit delimiter (606), Picture Parameter Set (607), Picture Timing SEI (608), and Coded Slice Data (609) are encoded.

In the above processing, Sequence Parameter Set (601) and Buffering Period SEI (602) of each picture group in the segment are repeatedly encoded. A set of frames from encoding the Buffering Period SEI (602) to encoding next Buffering Period SEI (602) are called a Buffering Period (Hereinafter, “BP”). In other words, the Buffering Period (BP) represents one picture group in the segment.

[3] Data Structure:

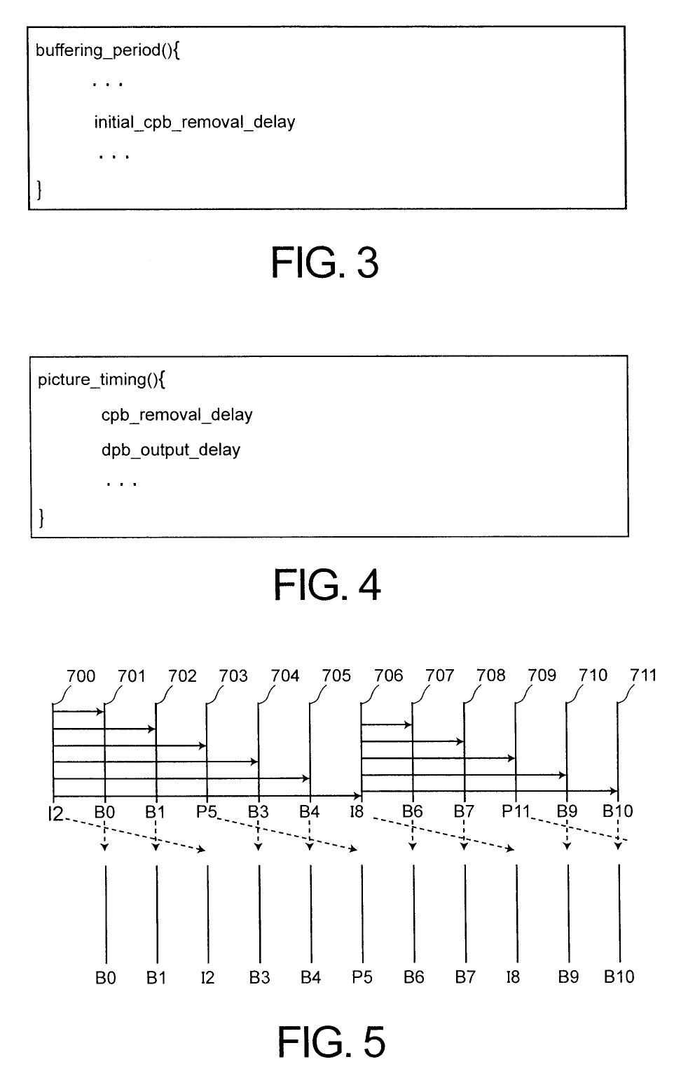

FIG. 3 is one example of data structure of Buffering Period SEI (602). As to Buffering Period SEI (602), in case of decoding, “initial_cpb_removal_delay” representing delay from input timing of a first frame of BP (into a receiving buffer of a decoder) to decode start timing of the first frame is decoded.

FIG. 4 is one example of data structure of Picture Timing SEI (604, 608). As to Picture Timing SEI (604, 608), “cpb_removal_delay” representing timing information of decoding timing of each frame, and “dpb_output_delay” representing delay from decoding timing to display timing of each frame are decoded.

[4] Explanation of Encoding Order:

FIG. 5 is a schematic diagram of a relationship between encoding order and decoding order of each frame. In FIG. 5, “700˜711” represents encoding order of each frame. “I2, B0, B1, . . . ” represents encoded picture type (alphabet) and display order (affixed number). “I” represents intra-frame encoded picture, “P” represents inter-frame encoded picture of single direction, and “B” represents inter-frame encoded picture of bi-direction.

In FIG. 5, frames 700˜705 compose a first BP (Buffering Period), and frames 706˜711 compose a second BP. In H.264, as to “cpb_removal_delay” of each frame, delay from decoding timing of a first frame to decoding timing of each frame in the BP is decoded.

In this case, as to “cpb_removal_delay” of a first frame in the BP, delay from decoding timing of a first frame of a previous BP to decoding timing of the first frame of the BP is encoded. As only one exception, as to a head frame of a first segment in a motion picture sequence, “cpb_removal_delay” is set by “0”.

In this way, neighboring two BPs are seamlessly encoded. After decoding each encoded frame in order of encoding (700˜711), each decoded frame is displayed by arranging in order of display (motion picture sequence).

In the lower part (B0, B1, I2, B3, . . . ) of FIG. 5, each encoded frame is arranged in order of display after decoding. In FIG. 5, as to an encoded frame B, “dpb_output_delay” is encoded as “0” so that the encoded frame B is simultaneously decoded and displayed. Furthermore, as to encoded frames I and P, “dpb_output_delay” is encoded as delay of three frames period so that the encoded frames I and P are respectively displayed by three frames period later from decoding.

[5] Encoding Processing of Each Segment:

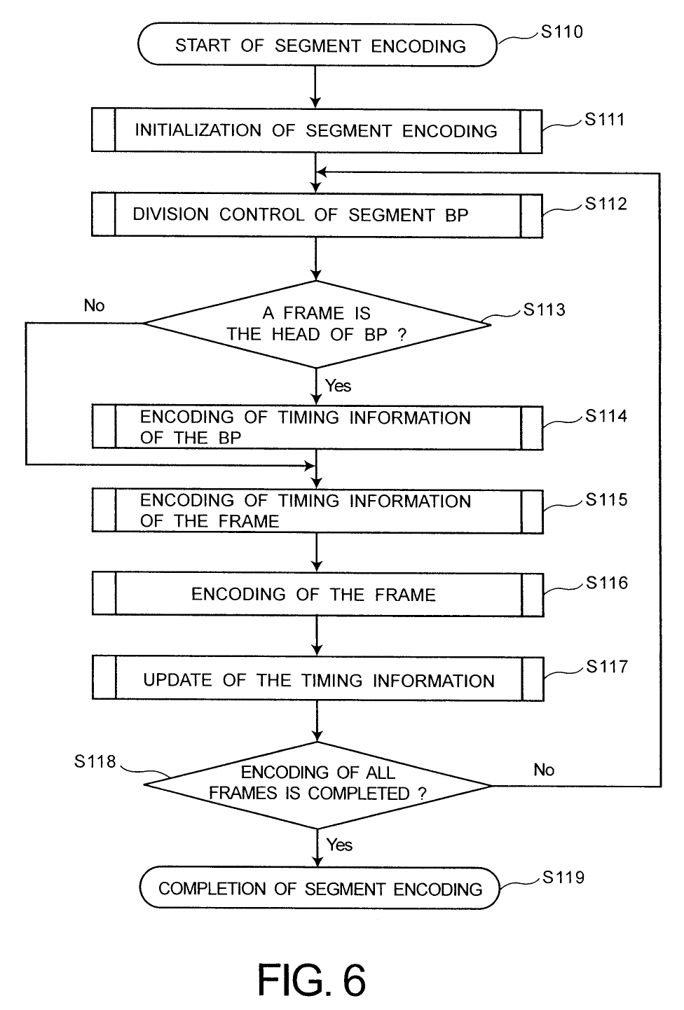

Next, encoding processing (S103) of each segment in FIG. 1 is explained by referring to a flow chart of FIG. 6. In the present embodiment, each segment is encoded in order frame by frame.

First, at the start of segment encoding (S110), encoding parameter of the segment is set as initialization processing (S111). Next, the segment is divided into a plurality of BPs (picture groups) each having a plurality of continuous frames (S112). As a result of BP-division control at S112, if a frame to be encoded next is a head frame of the BP (Yes at S113), “Buffering Period SEI” as timing information of the BP is encoded (S114). Next, “Picture Timing SEI” as timing information of the frame is encoded (S115), and the frame is encoded (S116).

When encoding of one frame is completed, control parameter of encoding timing and display timing of the frame is updated (S117), and encoding of all frames in the segment is decided to be completed (S118). Until encoding of all frames in the segment is completed, processing S112˜S118 is repeated. When encoding of all frames in the segment is completed, encoding of the segment is completed (S119).

[6] Summary and Operation of BP-Length Control:

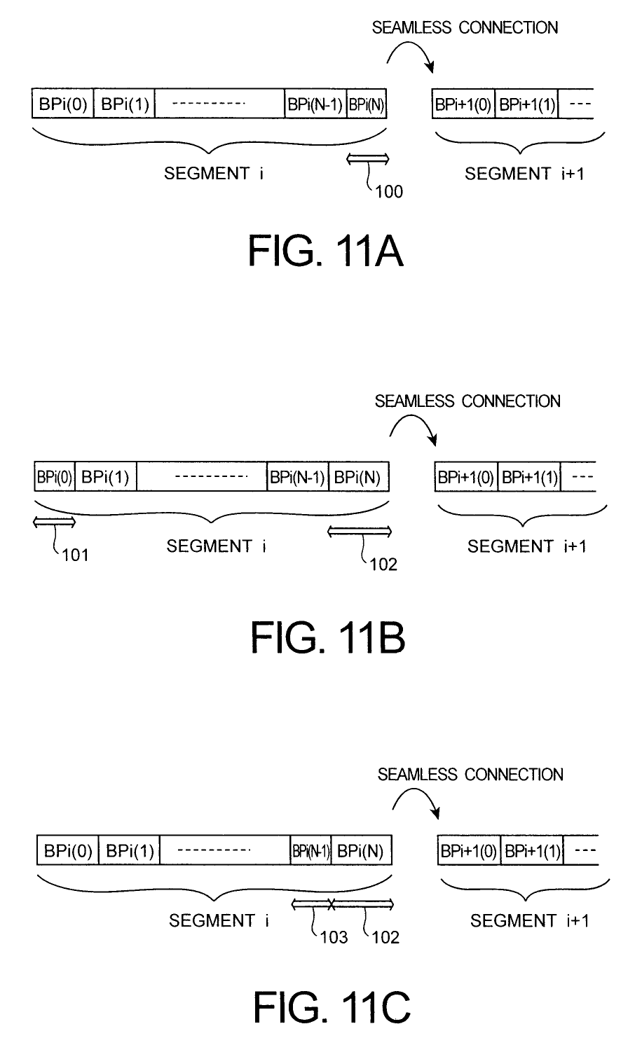

Next, summary and operation of BP-length control according to the present embodiment is explained by referring to FIGS. 11A-C, 12A-B and 13A-B. FIGS. 11A˜11C show examples that the segment is divided into a plurality of BPs each comprising a plurality of frames. In FIGS. 11A˜11C, a horizontal direction represents passage of time. Each segment is independently encoded, and encoded data of each segment is connected. Last, encoded data of connected segments are output as seamless playable back motion picture.

Usually, BP is consisted of fixed BP-length (fixed number of frames composing BP). However, in FIGS. 11A˜11C, a total number of frames of segment i is not equal to a multiple of the fixed BP-length.

### [6-1] Comparative Example

First, a comparative example is explained. In FIGS. 11A˜11C, segment i certainly includes BP having BP-length as a fraction. As shown in FIG. 11A, if BP-length of the last BP 100 in segment is adjusted, a number of frames of the last BP 100 in segment impacts the value of “cpb_removal_delay” of the head BP in segment i+1. Accordingly, until the BP-length of the last BP 100 in segment i is determined, encoding of segment i+1 cannot be started.

Briefly, BP-length of the last BP of each segment is not determined until encoding of the segment is completed. In this case, when each segment is encoded in parallel and encoded data of each segment is connected, a value of “cpb_removal_delay” of a head BP of each segment cannot be correctly encoded. As a result, motion picture of connected segments cannot be normally played back.

In order to solve this problem, a temporary value of “cpb_removal_delay” of a head BP of each segment is encoded before BP-length of a last BP of a previous segment is determined, and each segment is parallely encoded. After encoding of all segments is completed, a value of “cpb_removal_delay” of the head BP of each segment is re-calculated and written onto encoded data of the head BP of each segment. As a result, encoded data (of connected segments) continuously playable back can be generated. However, in this case, a processing step to correct encoded data of the head BP after encoding is necessary.

Furthermore, if encoded data to be corrected includes variable-length code or arithmetic code, correction area of the encoded data is not localized, and correction of encoded data of wide area is necessary.

Furthermore, amount of encoded data varies by correcting the encoded data, and occupancy of a virtual buffer does not often satisfy the restriction condition. If BP-length of a last BP of each segment is previously determined, a plurality of continuous segments can be encoded in parallel. However, if segment-length (a number of frames in segment) is variable, BP-length of the last BP of each segment is not generally fixed. Accordingly, timing information of a head BP of each segment is not fixed.

After encoding of each segment is completed, editing of encoded data is often operated by rearranging encoded data of each segment. In this case, even if following three conditions for segment delimiter are guaranteed, continuity of timing information is not guaranteed.

(1) Connectivity of occupancy in a virtual buffer

(2) Continuity of field phase

(3) Prohibition of inter-frame prediction

### As a result, encoded data continuously playable back cannot be generated.

### [6-2] The First Embodiment

Next, in the first embodiment, as shown in FIGS. 11B and 11C, BP-length of any BP except for the last BP in each segment is corrected. Briefly, BP-length of any BP is corrected so that BP-length of the last BP in each segment is a constant value.

In FIG. 11B, BP-length of a head BP 101 in segment is corrected. In FIG. 11C, BP-length of a second last BP 103 in segment i is corrected. In this way, by fixing the BP-length of the last BP 102 (104) in segment i, bad effect to generate timing information of a head BP of a next segment i+1 can be excluded.

In this way, when a plurality of segments are encoded in parallel and encoded data of each segment is connected, without rewriting timing information in the encoded data, encoded data of motion picture continuously playable back can be generated.

Furthermore, if above three conditions (1)˜(3) are guaranteed, when encoded data of each segment is arbitrary replaced, encoded data continuously playable back can be generated without rewriting timing information in the encoded data. As a result, editing of encoded data level can be easily operated.

[7] The Case of Detection of Scene Change Point:

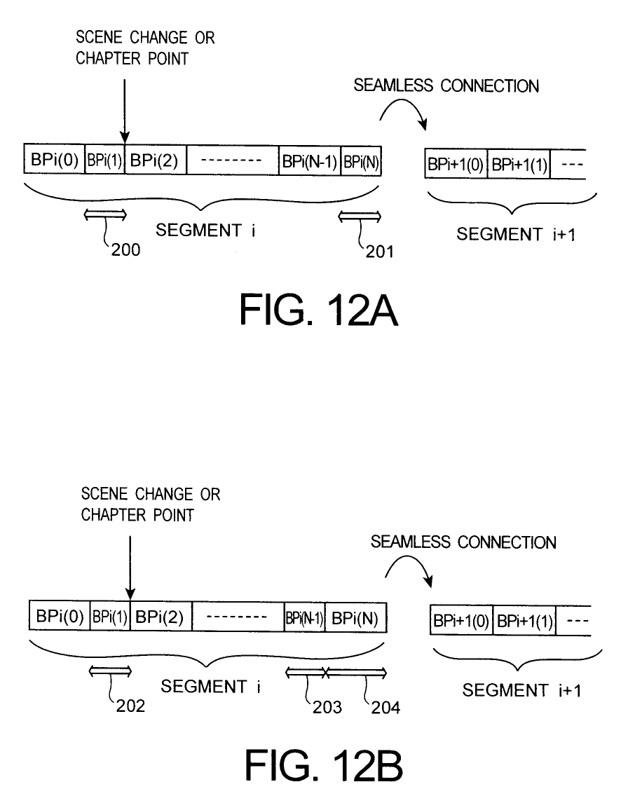

If a scene change point is detected from a motion picture while encoding a segment, the segment can be divided into a plurality of BPs based on the scene change point. Furthermore, if a chapter point (start point of random access) is set from the outside, the segment can be divided into a plurality of BPs based on the chapter point. FIG. 12 shows this example of BPs divided from the segment.

As to the H.264 standard, in case of random-access playback, a delimiter point between neighboring two BPs is often set as a start point of playback because initialization of timing information for playback is easy. Accordingly, by encoding each segment so that a scene change point or a chapter point matches a BP-delimiter, random-access in playback can be easily operated.

In FIGS. 12A and 12B, a segment i is divided by a scene change point or a chapter point (BP(1)), and next BP is started from the scene change point or the chapter point (BP(2)). Briefly, the scene change point or the chapter point can be matched with the BP-delimiter.

In this way, if the number of frames is dynamically varied in a segment, BP-length of the last BP in the segment is not generally a predetermined value. However, in the present embodiment, by adjusting BP-length of the second to last BP 203 (BP(N−1)), the segment i is encoded so that BP-length of the last BP 204 (BP(N)) is a predetermined value. As a result, parallel-encoding of each segment, and editing of encoded data of each segment can be easily executed.

[8] The Case of Seamless Multi-Story Encoding:

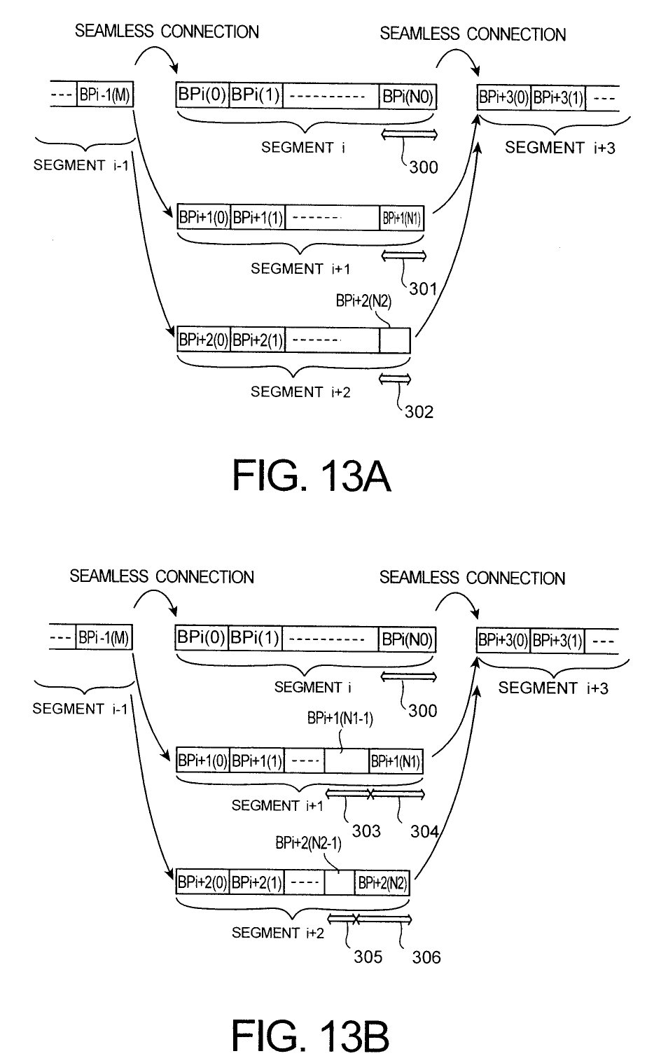

FIGS. 13A and 13B are examples to explain control of BP-length in seamless multi-story encoding. As to “seamless multi-story”, a plurality of motion picture patterns (multi-story) is previously prepared in encoded data of motion picture. While the encoded data of a main motion picture is played back (decoded), playback control is branched to one of the plurality of motion picture patterns at a branch point of the main motion picture. When playback of the one motion picture pattern is completed, playback control is returned to the main motion picture at a connection point. Accordingly, the plurality of motion picture patterns (multi-story) is selectively played back. In this case, at the branch point and the connection point, motion picture continuously playable back is called “seamless multi-story”.

In FIGS. 13A and 13B, playback control of encoded data is branched from a main motion picture (segment i−1) to one of three stories (segments i, i+1, i+2), and returned to the main motion picture (segment i+3).

In the first embodiment, a motion picture is divided into segments by at least branch unit (segment i, i+1, i+2) and encoded. As to H.264, in order to seamlessly play back encoded data at the branch point and the connection point, in addition to above conditions (1)˜(3), continuity of timing information should be guaranteed at the branch point and the connection point. On the other hand, if a number of frames of each segment i, i+1, i+2 (corresponding to multi-story) is not equal, BP-length of the last BP 300, 301, 302 in each segment is not equally fixed.

In case of returning from multi-story to a main single story, any one of encoded data of multi-story should be seamlessly connected to encoded data of the main single story. As shown in FIG. 13A, from all segments i, i+1, i+2 each having different BP-length of the last BP, encoded data of single segment seamlessly connectable cannot be generated.

On the other hand, in the present embodiment, as shown in FIG. 13B, BP-length (a number of frames) of BP except for the last BP in segment (For example, second end BP 303, 305) is adjusted. In this case, BP-length of the last BP in each segment i, i+1, i+2 (multi-story) is equally fixed. Accordingly, at a connection point from the multi-story (segments i, i+1, i+2) to a main story (segment i+3), motion picture can be seamlessly reproduced by returning from any encoded data of the multi-story to encoded data of the main story.

[9] Example of BP-Length Control:

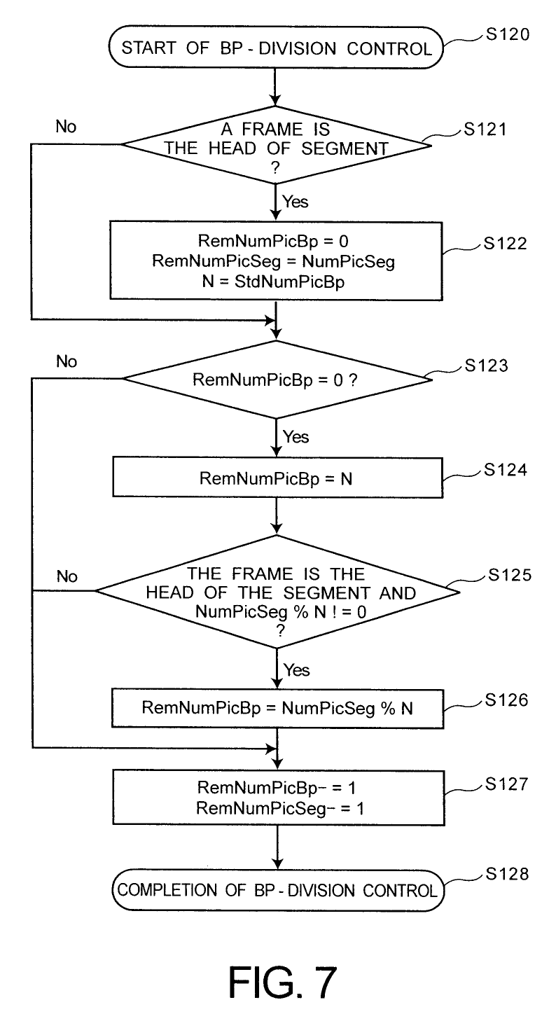

Next, a more detailed method for controlling BP-length (S112 in FIG. 6) of the present embodiment is explained by referring to FIGS. 7˜10.

[9-1] The First Method:

FIG. 7 is a flow chart of control processing in case of correcting BP-length of a head BP in each segment as shown in FIG. 11B. First, when BP-division control is started (S120), a frame (to be encoded next) is decided to be a head frame in the segment (S121).

If the frame is the head frame in the segment, a variable “RemNumPicBp” is set to “0”, a variable “RemNumPicSeg” is set to “NumPicSeg” (a total number of frames of the segment), and a variable N is set to “StdNumPicBp” (a predetermined standard BP-length) (S122). In this case, the variable “RemNumPicBp” represents a number of remaining frames (not encoded yet) in the BP, and the variable “RemNumPicSeg” represents a number of remaining frames (not encoded yet) in the segment.

Next, the variable “RemNumPicBp” is determined to be “0” (S123). In case of “0”, a frame to be encoded next is a head frame in the BP. In this case, the variable “RemNumPicBp” is set by “N” (S124). Furthermore, if this frame is a head frame in the segment and a fraction that the variable “NumPicSeg” is divided by N is not “0”, i.e., if a total number of frames in the segment cannot be divided by a standard BP-length (Yes at S125), the variable “RemNumPicBp” is correctly rewritten so that BP-length of the head BP is the fraction (S126). Next, the variable “RemNumPicBp” and the variable “RemNumPicSeg” are respectively subtracted by “1” (S127).

In this way, if a total number of frames in the segment cannot be divided by a standard BP-length, by correcting BP-length of the head BP in the segment, BP-length of the last BP in the segment can be the standard BP-length. As a result, parallel encoding of each segment, editing of encoded data of each segment, and connection with seamless multi-story can be easily executed.

[9-2] The Second Method:

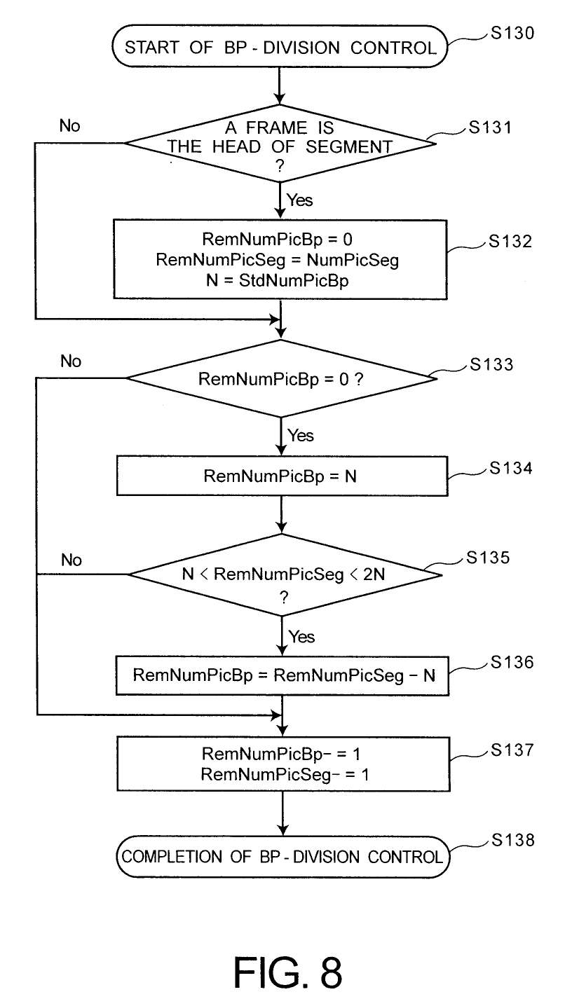

FIG. 8 is a flow chart of control processing in case of correcting BP-length of a second to last BP in each segment as shown in FIGS. 11C, 12B and 13B. First, when BP-division control is started (S130), a frame (to be encoded next) is decided to be a head frame in the segment (S131).

If the frame is the head frame in the segment, a variable “RemNumPicBp” is set to “0”, a variable “RemNumPicSeg” is set to “NumPicSeg” (a total number of frames of the segment), and a variable N is set to “StdNumPicBp” (a predetermined standard BP-length) (S132). In this case, the variable “RemNumPicBp” represents a number of remaining frames (not encoded yet) in the BP, and the variable “RemNumPicSeg” represents a number of remaining frames (not encoded yet) in the segment.

Next, the variable “RemNumPicBp” is decided to be “0” (S133). In case of “0”, a frame to be encoded next is a head frame in the BP. In this case, the variable “RemNumPicBp” is set by “N” (S134). Furthermore, if the variable “NumPicSeg” is above “N” and below “2N” (Yes at S135), the variable “RemNumPicBp” is correctly rewritten by “RemNumPicSeg−N” (S136). Next, the variable “RemNumPicBp” and the variable “RemNumPicSeg” are respectively subtracted by “1” (S137).

In this way, if a total number of frames in the segment cannot be divided by a standard BP-length, by correcting BP-length of the second to last BP in the segment, BP-length of the last BP in the segment can be the standard BP-length. As a result, parallel-encoding of each segment, editing of encoded data of each segment, and connection with seamless multi-story can be easily executed.

[9-3] The Third Method:

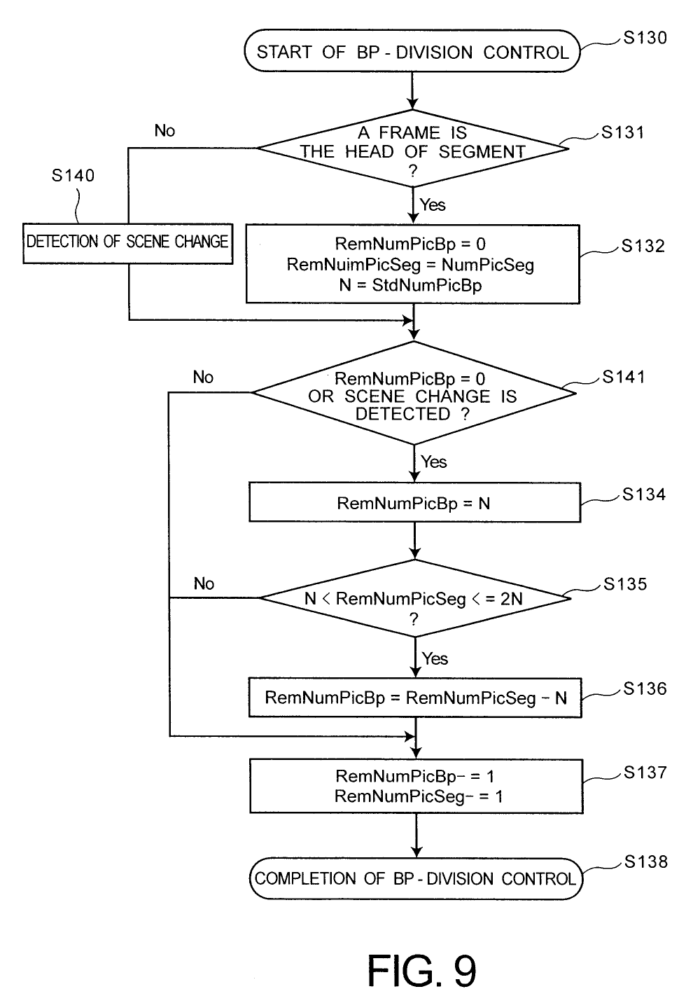

As shown in FIG. 12B, when a scene change point is detected during encoding of each segment, BP-length is corrected by setting the scene change point as BP-delimiter. In this case, in the third method, BP-length of the second to last BP in the segment is corrected. FIG. 9 is a flow chart of BP-division control processing of the third method.

In FIG. 9, in addition to FIG. 8, a scene change detection step (except for the head BP) S140 is added. Furthermore, a head BP decision step S133 in FIG. 8 is replaced with a BP-delimiter decision step S141 in FIG. 9. In step S141, it is decided whether “RemNumPicBp” (a number of remained frames in BP) is “0” and a scene change point is detected. Other steps in FIG. 9 are the same as in FIG. 8.

As to the scene change detection step S140, an inter-frame difference value of motion picture is calculated. If the inter-frame difference value is above a threshold, a scene change point is detected between two frames from which the inter-frame difference value is calculated.

In this way, the next BP starts from the scene change point (present BP terminates at the scene change point), and BP-length of the last BP in the segment is fixed. As a result, random playback from the scene change point can be easily executed. Furthermore, parallel-encoding of each segment, editing of encoded data of each segment, and connection with seamless multi-story can be easily executed.

[9-4] The Fourth Method:

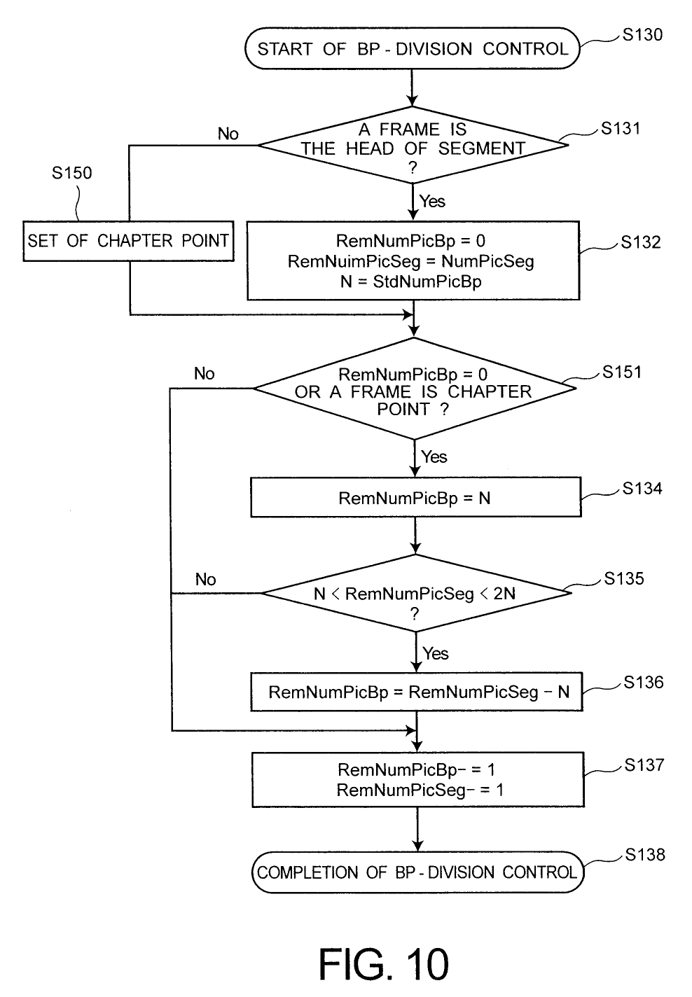

As shown in FIG. 12B, when a chapter point is set from the outside, BP-length is corrected by setting the chapter point as BP-delimiter. In this case, in the fourth method, BP-length of the second to last BP in the segment is corrected. FIG. 10 is a flow chart of BP-division control processing of the fourth method.

In FIG. 10, a scene change detection step S140 in FIG. 9 is replaced with chapter point set step S150. Furthermore, a head BP decision step S141 in FIG. 9 is replaced with a BP-delimiter decision step S151 in FIG. 10. In step S151, it is decided whether “RemNumPicBp” (a number of remained frames in BP) is “0” and whether a frame to be encoded next corresponds the chapter point. Other steps in FIG. 9 are the same as in FIG. 8.

As to the chapter point set step S150, the chapter point is set by a frame number or a time code of motion picture from the outside. By comparing a frame number (or a time code) of a frame to be encoded next with a frame number (or a time code) of the chapter point, the frame is decoded to be the chapter point.

In this way, next BP starts from the chapter point (present BP terminates at the chapter point), and BP-length of the last BP in the segment is fixed. As a result, random playback from the chapter point can be easily executed. Furthermore, parallel-encoding of each segment, editing of encoded data of each segment, and connection with seamless multi-story, can be easily executed.

Control of Field Phase:

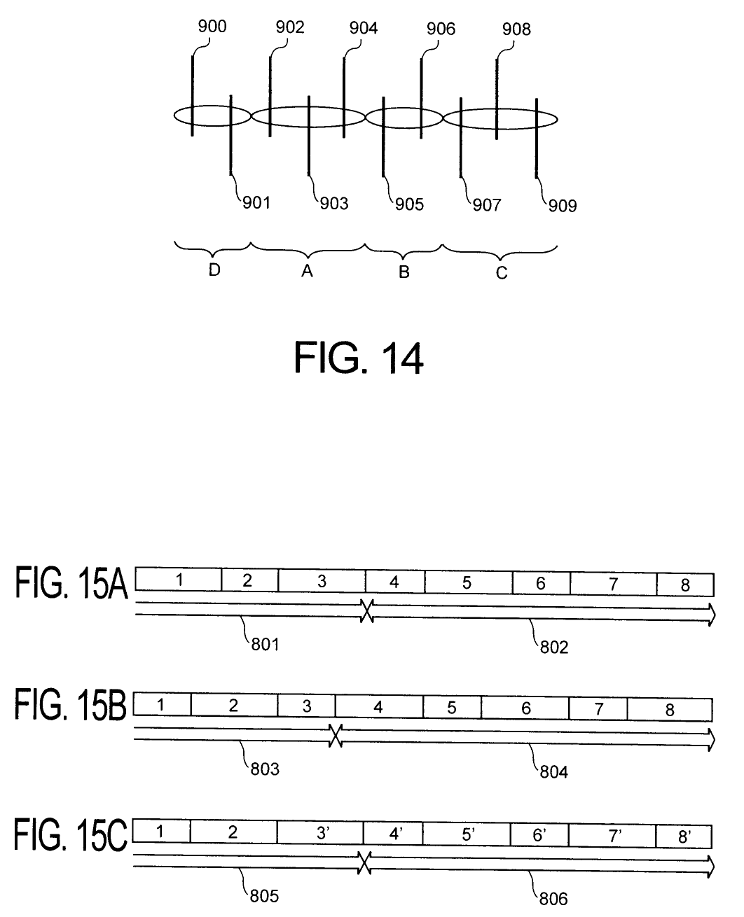

Next, by referring to FIGS. 14˜16, control of field phase of the present embodiment is explained. As to film material such as a cinema, the material having frame rate 24 fps (Frame Per Second) is encoded and displayed as an interlace-display of 30 fps. In this case, 3:2 pull-down is used.

In 3:2 pull-down, after decoding a picture signal of one frame, the picture signal is divided into a field signal (top-field) comprising even number lines and a field signal (bottom-field) comprising odd number lines. A frame to display in three field period (by repeating the first field) and a frame to display in two field period are mutually repeated. Concretely, a signal of twenty-four frames per second is converted to a signal of sixty fields per second, and displayed.

FIG. 14 shows one example of 3:2 pull-down display. In FIG. 14, “900˜909” represent fields divided from a frame. “904, 902” and “909, 907” respectively represent the same fields repeatedly displayed. In this case, a frame to display in two field periods in order from top-field to bottom-field is D. A frame to display in three field periods in order from top-field to top-field via bottom-field is A. A frame to display in two field periods in order from bottom-field to top-field is B. A frame to display in three field periods in order from bottom-field to bottom-field via top-field is C. In case of 3:2 pull-down display, information representing any one of A, B, C and D is added to each encoded data.

Briefly, a display period of each frame is different. In this case, as explained in FIGS. 7-10, even if a number of frames of a last BP in each segment is fixed, parallel encoding of each segment, editing of encoded data of each segment, and connection with seamless multi-story cannot be easily executed.

FIGS. 15A˜15C show a last BP of each segment in case of 3:2 pull-down display (decoding period is mutually changed between two fields period and three fields period.). In FIG. 15A, frames 1, 3, 5 and 7 represent three fields period display, and frames 2, 4, 6 and 8 represent two fields period display. In FIG. 15B, frames 2, 4, 6 and 8 represent three fields period display, and frames 1, 3, 5 and 7 represent two fields period display. In FIG. 15A-15C, 802, 804, and 806 represent encoded pictures composing the last BP in each segment. In this example, a number of frames of the last BP is adjusted as five frames. However, even if the number of frames is same (five), if a field phase of 3:2 pull-down is different as shown in FIGS. 15A and 15B, decoding and display period of each BP is not fixed. As a result, “cpb_removal_delay” of a head BP of next segment is not fixed. In FIG. 15A, display time of the last BP is twelve fields. In FIG. 15B, display time of the last BP is thirteen fields. As to “cpb_removal_delay” in the first encoded picture of each BP, delay from decode timing of the first encoded picture of previous BP is encoded. As a result, in a head BP of next segment to be connected with the last BP 802 (804) in FIG. 15A (15B), “cpb_removal_delay” is not always fixed.

On the other hand, in the present embodiment, 3:2 pull-down pattern of encoded picture composing the last BP in each segment is equally matched. In this case, in case of 3:2 pull-down, decoding and display period of the last BP in each segment is fixed. Accordingly, “cpb_removal_delay” of the head BP in each segment can be fixed without waiting for the completion of encoding of a previous segment.

In order to equally match 3:2 pull-down pattern of encoded picture composing the last BP in each segment, 3:2 pull-down pattern of the second to last BP of each segment is adjusted. In FIG. 15A˜15C, in order to equally match 3:2 pull-down pattern of the last BP 804 (FIG. 15B) with 3:2 pull-down pattern of the last BP 802 (FIG. 15A), two fields-display period “3” of a previous BP 803 (FIG. 15B) is changed to three fields-display period “3′” of a previous BP 805 (FIG. 15C). As a result, 3:2 pull-down pattern of encoded picture 4˜8 to be connected with encoded picture 3′ in FIG. 15C is automatically set to 3:2 pull-down pattern 4′˜8′ in the same way as FIG. 15A.

A field phase of 3:2 pull-down has four patterns A˜D in FIG. 14. Under a constraint that two top fields are not adjacent and two bottom fields are not adjacent, the field phase can be adjusted.

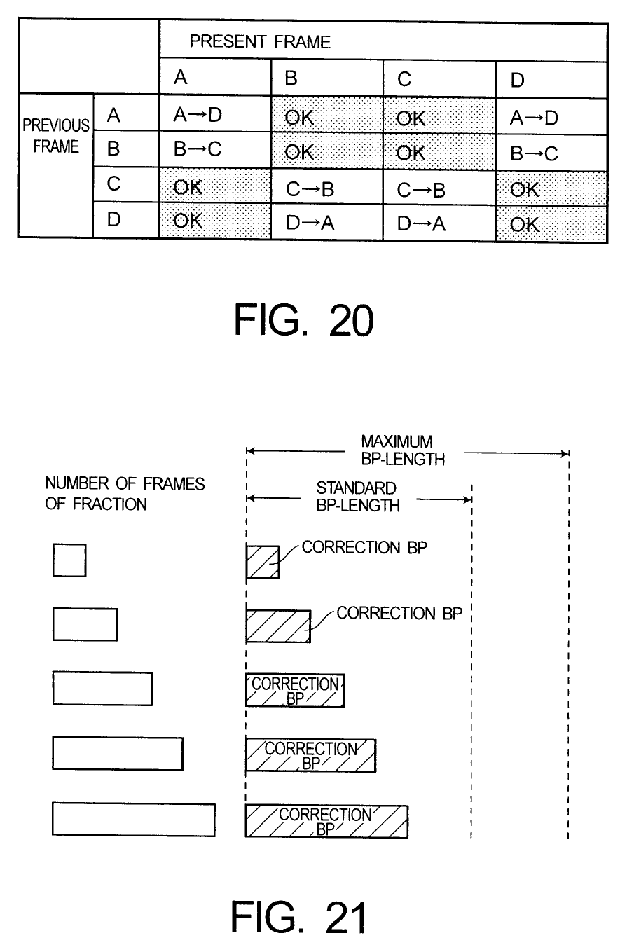

FIGS. 16A1, B1, C1 and D1 show examples of last BPs of four segments having different 3:2 pattern in order of display. In this example, “A, B, C and D” represent a display field pattern of each encoded frame in FIG. 14. As shown in FIGS. 15A˜C, in order to constantly fix 3:2 pattern in a last BP of each segment, 3:2 pattern of display frame of a previous segment of the segment is adjusted. In this case, 3:2 pattern need be adjusted based on continuity of a display field. FIG. 20 shows a conversation table to adjust 3:2 pattern in order to seamlessly play back continuous frames based on 3:2 pattern in FIGS. 15A˜C. In FIG. 20, a pattern “OK” represents 3:2 pattern that guarantees continuity of display field. For example, a pattern “A→D” represents that 3:2 pattern of a previous frame is changed from “A” to “D” to guarantee continuity of display field.

FIGS. 16A2, 16B2, 16C2 and 16D2 show examples that a last display frame of a previous BP is adjusted in order to fix 3:2 pattern of the last BP of each segment in FIGS. 16A1, 16B1, 16C1 and 16D1 based on control pattern in FIG. 20. Furthermore, FIGS. 16A3, 16B3, 16C3 and 16D2 show examples that 3:2 pattern of a last display frame of a previous BP is fixedly adjusted in order to fix 3:2 pattern of the last BP of each segment. In this way, by adjusting a phase pattern of 3:2 pull-down, the last BP can be controlled to have a predetermined phase pattern. As shown in FIG. 20, the predetermined phase pattern of the field phase may be set as a table. In this case, BP-division control (S112) in encoding flow (FIG. 6) of each segment, each segment is encoded by adjusting the field phase with the number of frames of BP.

As mentioned-above, in addition to control of the number of frames, the field phase of the last BP of each segment is adjusted as a predetermined value. Accordingly, in case of 3:2 pull-down display, parallel encoding of each segment, editing of encoded data of each segment, and connection with seamless multi-story can be executed.

[11] Component of Motion Picture Encoding Apparatus:

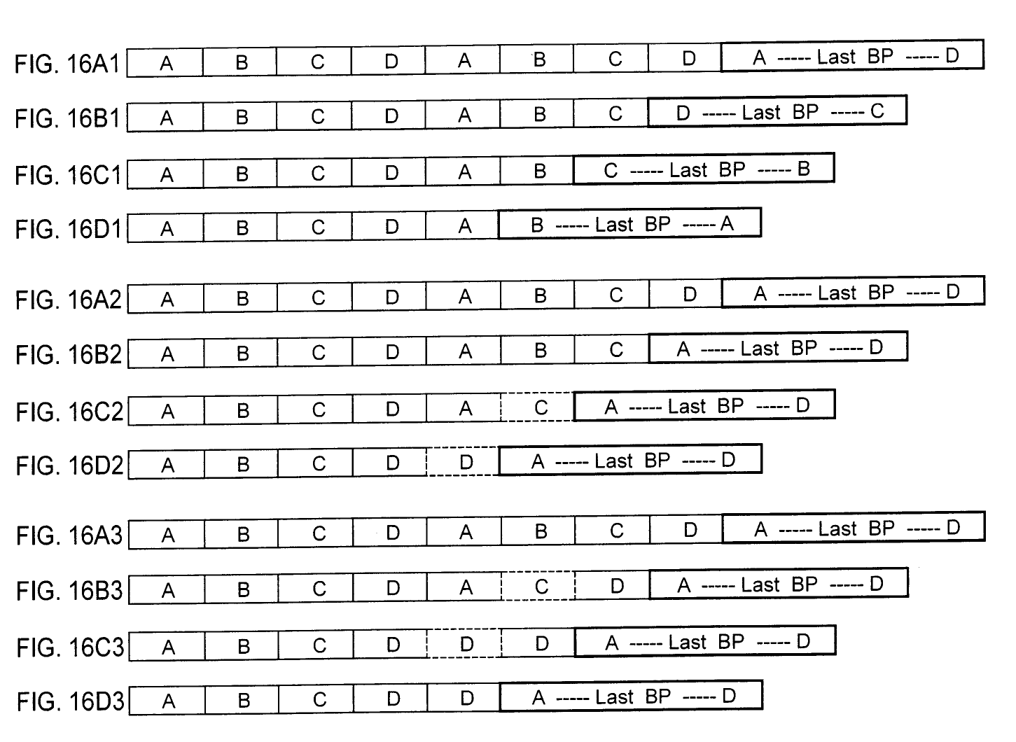

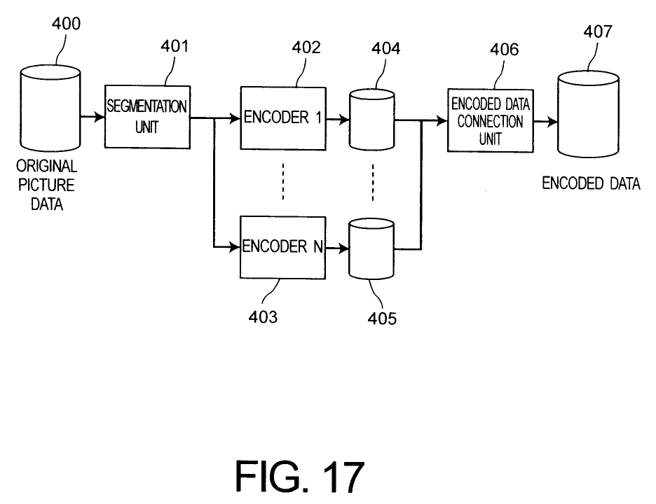

Next, components of a motion picture encoding apparatus of the present embodiment are explained by referring to FIGS. 17-19. FIGS. 17˜19 show component of the motion picture encoding apparatus which realizes the above-mentioned encoding method. Each processing unit may be composed by special purpose hardware, software and special purpose hardware, or a general purpose CPU and software. Furthermore, these components may be combined.

[11-1] First Component:

FIG. 17 is a block diagram of the motion picture encoding apparatus which executes encoding processing in FIG. 1. A motion picture signal of an encoding object is preserved in a storage medium 400 composed by a hard disk or a large capacity memory (each randomly readable).

A segmentation unit 401 divides the motion picture signal (preserved in the storage medium 400) into a plurality of segments. Furthermore, the segmentation unit 401 reads original picture data of each segment, and distributes the segments to a plurality of encoders 402˜403.

The encoders 402˜403 encode the segments in parallel based on the number of segments. Encoded data of the segments is output to a storage medium 404˜405 such as a memory or a hard disk for temporal preservation.

After completion of encoding each segment, an encoded data connection unit 406 reads encoded data of each segment from the storage medium 404˜405 in order of display, connects the encoded data, and outputs encoded data as a connection result to a storage medium 407.

[11-2] Second Component:

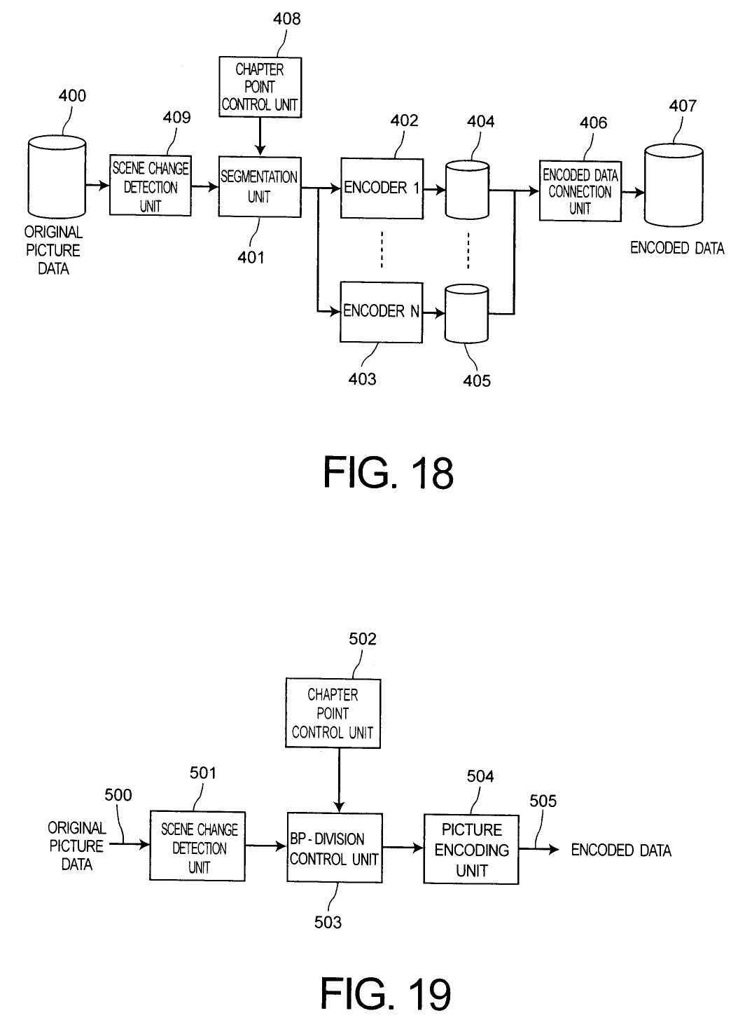

In FIG. 18, in addition to component of FIG. 17, a scene change detection unit 409 is located between the storage medium 400 (storing the original picture) and the segmentation unit 401. Furthermore, a chapter point control unit 408 is connected to the segmentation unit 401.

The scene change detection unit 409 detects a scene change point of the motion picture signal of the encoding object. Furthermore, the chapter point control unit 408 sets a chapter point to be randomly accessed for playback as a frame number or a time code. The segmentation unit 401 divides picture data into segments at the scene change point or the chapter point. In this case, inter-frame prediction is cut at a delimiter of the segment. Accordingly, random-access while playing back encoded picture data is easy.

Furthermore, in the second component, each segment is encoded so that encoded data is edited by unit of segment. In this case, by matching the scene change point (or the chapter point) with a delimiter of the segment, encoded data which is easy to be edited by unit of scene (or chapter) can be generated.

[11-3] Third Component:

FIG. 19 is a block diagram of each encoder 402˜403 in FIG. 17. In FIG. 19, original picture data 500 of a segment is input to the encoder by unit of frame. In necessary, a scene change detection unit 501 detects a scene change point. Furthermore, a chapter point control unit 502 sets a chapter point to be randomly accessed (in playing back) as a frame number or a time code. In addition to periodical BP-division, a BP-division control unit 503 compulsorily divides the original picture data 500 (segment) into a plurality of BPs at the scene change point or the chapter point. A picture encoding unit 504 encodes frames of each BP of the segment in order, and outputs encoded data 505 of the segment.

By setting the scene change point (or the chapter point) as BP-division point, random access while playing back encoded data is easy. Furthermore, by installing the scene change detection unit 501 into each encoder 402˜403, scene change detection processing is paralleled in proportion to parallel degree of the encoders. Accordingly, in comparison with FIG. 18 (one scene change detection unit 409 detects all scene change points in the picture data), scene change detection processing can be quickly executed.

[11-4] Summary of Component:

By using the motion picture encoding apparatus shown in FIGS. 17˜19, motion picture encoding methods explained in FIGS. 6˜16 are executed. Accordingly, parallel encoding of each segment, editing of encoded data of each segment, and connection with seamless multi-story can be executed. In case of displaying by 3:2 pull-down, above-mentioned effect is also obtained.

[12] In Case that Each BP has the Same Structure as GOP:

Next, in the first embodiment, the case that each BP has the same structure as GOP (Group of Pictures) defined by MPEG2 video standard (ISO/IEC13818-2) is explained. As to GOP, a first picture in order of encoding is encoded as I picture of intra-frame encoded picture. In GOP following from I picture, P picture for inter-frame predicted encoding along single direction and B picture for inter-frame predicted encoding along bidirection are combinationaly encoded. Briefly, at least one I picture is included in each GOP. By always existing I picture decodable as a single frame (without inter-frame prediction) in each GOP, random-access and trick play, such as fast forward and fast reverse, is possible.

In the case that each BP has GOP structure, each BP includes at least one I picture. I picture is encoded without inter-frame correlation, and its compression efficiency is usually lower than P picture and B picture. Furthermore, a head I picture in BP (a head picture in GOP) is used as the starting point of inter-frame prediction in BP. In order to raise quality of compressed picture of all BP, I picture is often compressed with higher quality than P picture and B picture.

In order for I picture (with low encoding efficiency) to compress as high quality, a large encoded bits generate from I picture. Accordingly, when I picture is frequently encoded, encoded bits to obtain a predetermined quality increase, and the quality falls with quantization under a fixed encoded bits. Briefly, in general, the shorter a BP-length is, the lower an averaged encoding efficiency is. In other words, the longer the BP-length is, the higher the averaged encoding efficiency is.

However, as mentioned-above, a head picture in BP is encoded as I picture in order to easily execute random-access and trick play. Accordingly, if the BP-length lengthens, functionality to play back BP falls.

[12-1] The First Control Method of BP-Length:

FIG. 21 shows examples of BP-length corrected by the first control method of BP-length in FIGS. 7-10 according to the first embodiment. In the first embodiment shown in FIGS. 7-10, if a number of frames of each segment has a fraction below a standard BP-length, a short BP having frames of the fraction is located at a head position or a second end position in the segment. Accordingly, BP-length corrected by the first control method in FIG. 21 is shorter than the standard BP-length. In this case, random-access operability does not fall, but encoding efficiency falls for the corrected BP-length.

[12-2] The Second Control Method of BP-Length:

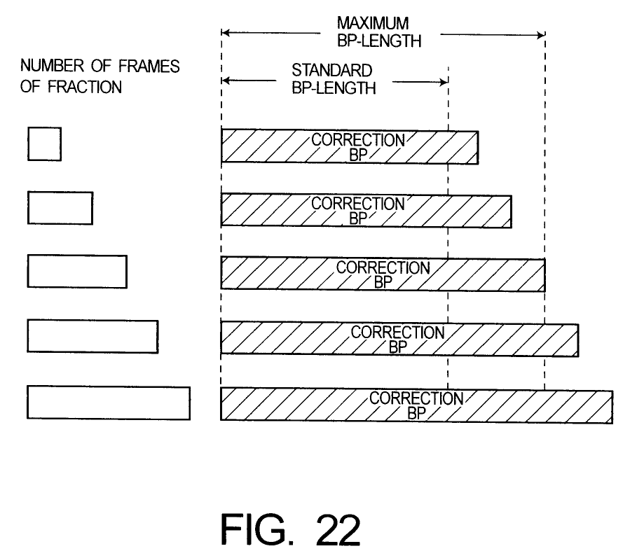

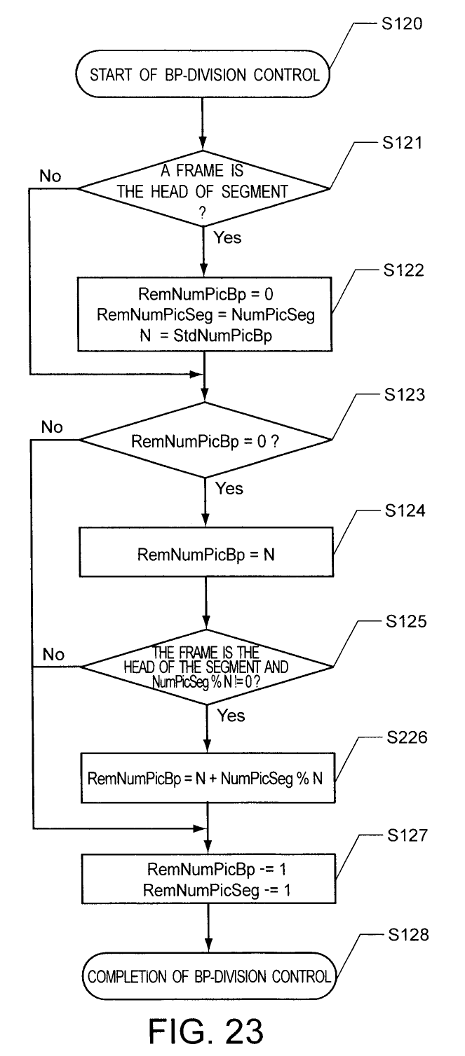

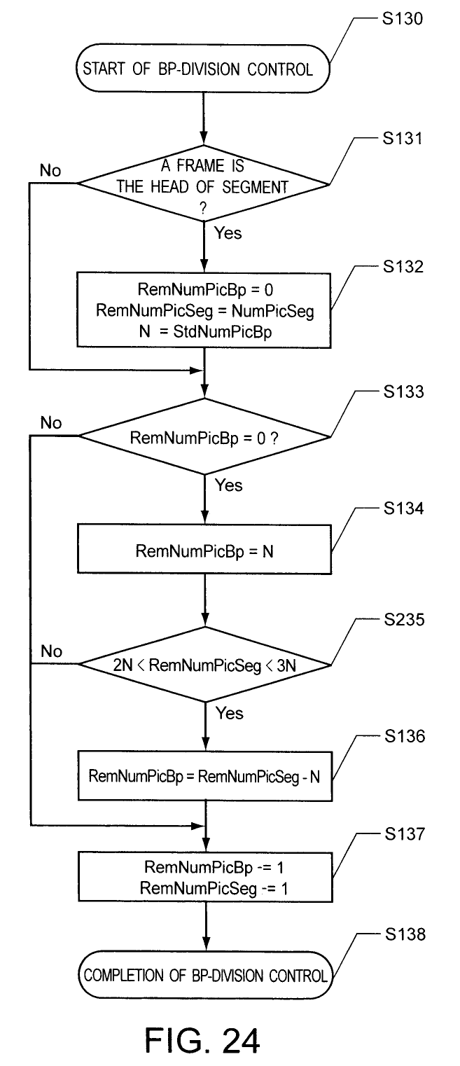

FIGS. 22, 23 and 24 show examples of BP-length corrected by the second control method of BP-length according to the first embodiment. As shown in FIG. 22, in the second control method, instead of a short BP having frames of the fraction, a number of frames of the fraction is compensated by a long BP having frames of which number is sum of the fraction and the standard BP-length. BP-length control in FIG. 22 is realized using BP-division control method in FIG. 23 or FIG. 24 instead of BP-division control method in FIGS. 7˜10.

FIG. 23 is a flow chart of processing that a number of frames of the fraction is compensated by a head BP in the segment. I order to realize such processing, step S126 in FIG. 7 is replaced with step S226 in FIG. 23, i.e., BP-length of a head BP in the segment is set as a sum of the fraction and the standard BP-length N.

FIG. 24 is a flow chart of processing that a number of frames of the fraction is compensated by a second end BP in the segment. I order to realize such processing, step S135 (condition decision part) in FIG. 8 is replaced with step S235 in FIG. 24, i.e., a BP to be corrected (it is called “a correction BP”) is set at a BP-delimiter that a number of unencoded frames in the segment is above double standard BP-length and below triple standard BP-length. As mentioned-above, by compensating the number of frames of the fraction with BP having length longer than the standard BP-length, generation of short BP is avoided, and fall of encoding efficiency by the fraction is prevented.

[12-3] The Third Control Method of BP-Length:

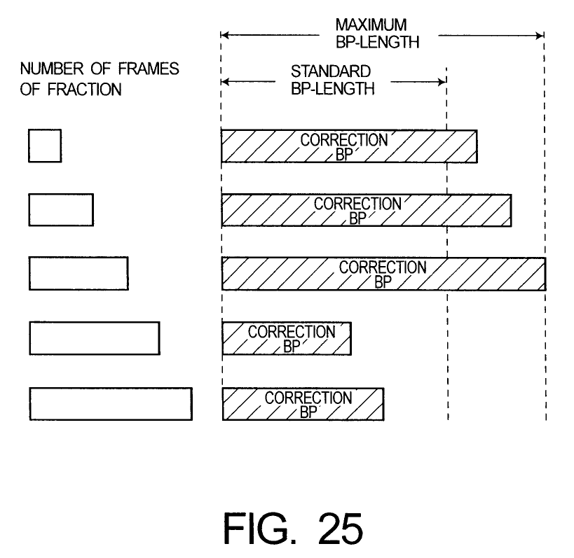

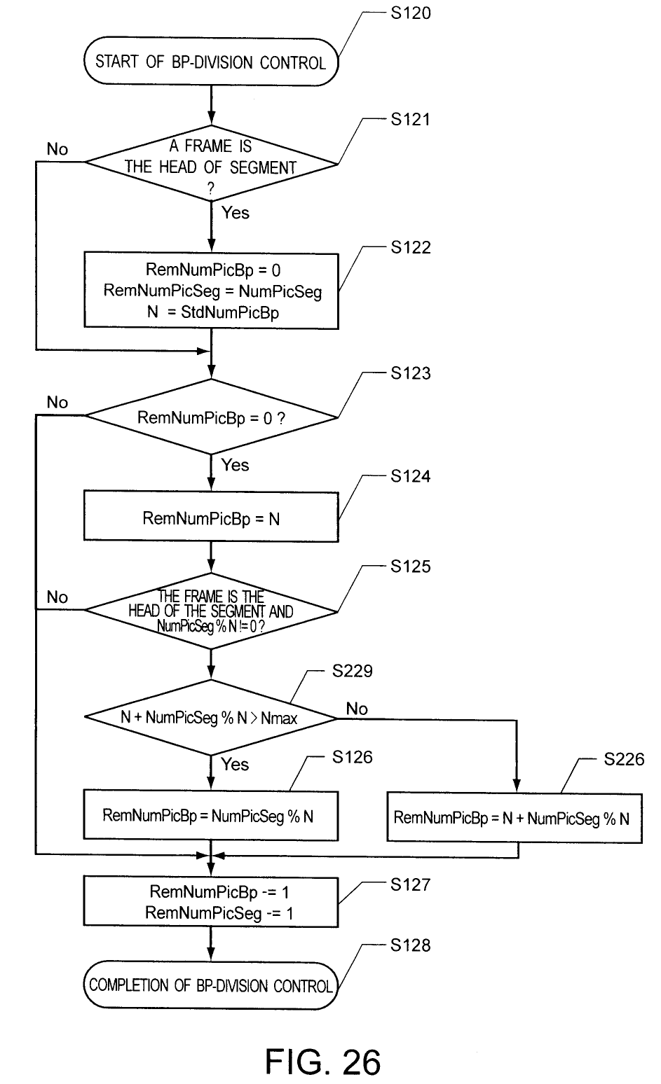

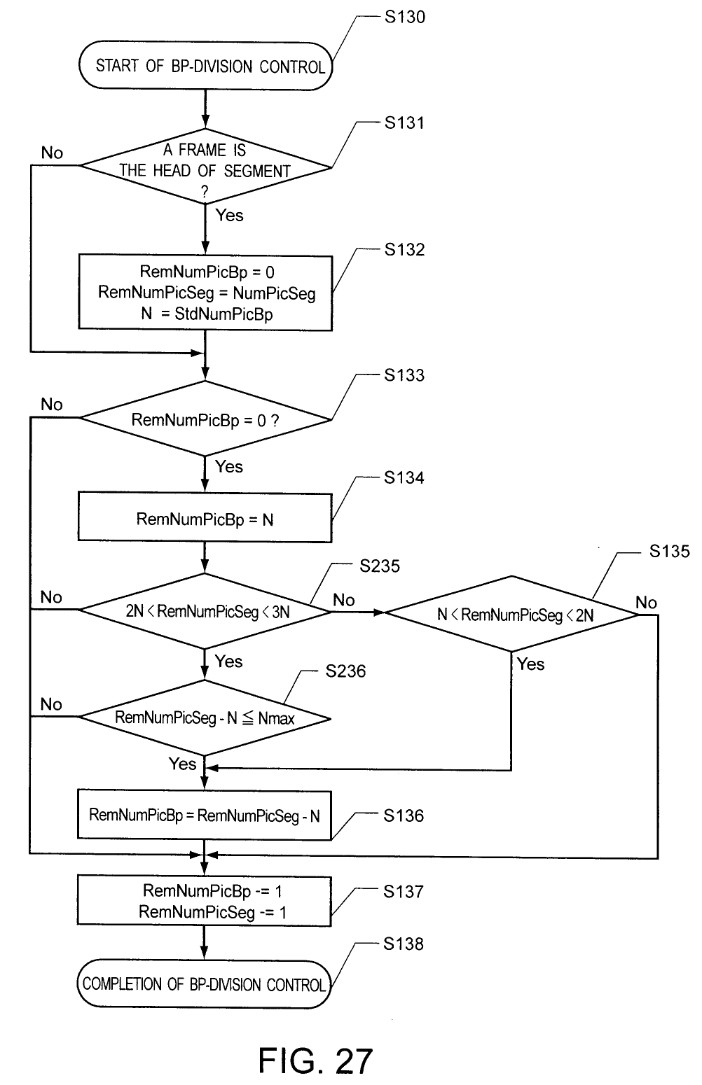

FIGS. 25, 26 and 27 show examples of BP-length corrected by the third control method of BP-length according to the first embodiment. As shown in FIG. 25, in the third control method, in order to suppress fall of encoding efficiency in the same way as FIG. 22, instead of a short BP having frames of the fraction, a number of frames of the fraction is compensated by a long BP having frames of which number is sum of the fraction and the standard BP-length. However, in the case that a BP-length to be corrected (it is called “a correction BP-length”) is above a predetermined maximum BP-length, the short BP having frames of the fraction is used. The BP control in FIG. 25 is realized using BP-division control method in FIG. 26 or FIG. 27 instead of BP-division control method in FIGS. 7˜10.

FIG. 26 is a flow chart of processing that a number of frames of the fraction is compensated by a head BP in the segment. Concretely, before step 126 in the flow chart of FIG. 7, it is decided whether the correction BP-length is above a maximum BP-length Nₘₐₓ (S229). If the correction BP-length is above the maximum BP-length, in the same way as FIG. 7, a short BP having frames of the fraction is set at a head position of the segment (S126). If the correction BP-length is not above the maximum BP-length, in the same way as FIG. 23, a BP-length of the head BP in the segment is set as a sum of the fraction and the standard BP-length N (S226). In this way, BP-length control in FIG. 25 is realized.

FIG. 27 is a flow chart of processing that a number of frames of the fraction is compensated by a second end BP in the segment. In the same way as FIG. 24, the correction BP-length is set at a BP-delimiter that a number of unencoded frames in the segment is above double standard BP-length and below triple standard BP-length. The correction BP-length is not above the maximum BP-length Nₘₐₓ (Yes at S236), in the same way as FIG. 24, the correction BP-length longer than the standard BP-length N is set (S136).

If the correction BP-length is above the maximum BP-length Nₘₐₓ (NO at S236), the standard BP-length is used without location of a long correction BP-length. Furthermore, at a BP-delimiter that a number of unencoded frames in the segment is above the standard BP-length N and below 2N (Yes at S135), in the same way as FIG. 8, a short correction BP is used. Then a BP-length of an end BP in the segment is fixed, and a BP-length of a second end BP in the segment is corrected within a range below the maximum BP-length Nₘₐₓ. In this way, a fraction of BP-length in the segment can be adjusted.

As mentioned-above, a correction BP to compensate a number of frames of the fraction is set within the maximum BP-length while generation of a short correction BP-length is minimally suppressed. Accordingly, fall of encoding efficiency can be suppressed by maintaining functionality of random-access and trick play.

[12-4] The Fourth Control Method of BP-Length:

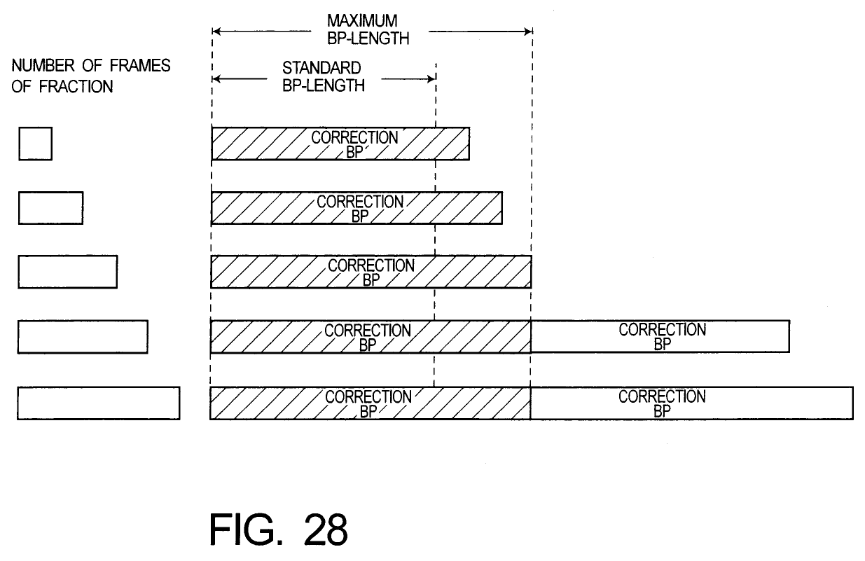

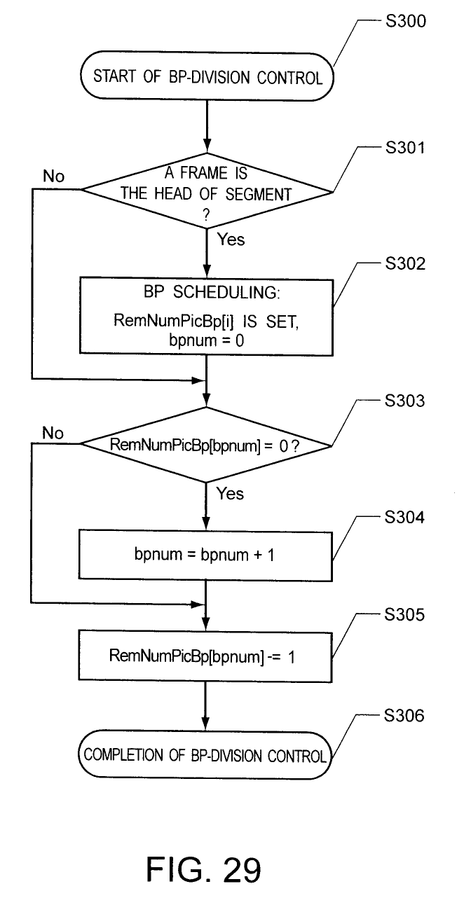

FIGS. 28 and 29 show examples of BP-length corrected by the fourth control method of BP-length according to the first embodiment. As shown in FIG. 28, in the fourth control method, in order to suppress fall of encoding efficiency in the same way as FIG. 22, instead of generation of a short BP having frames of the fraction, a number of frames of the fraction is compensated by a long BP having frames of which number is a sum of the fraction and the standard BP-length. In this case, if a correction BP-length (the sum) is above a predetermined maximum BP-length Nₘₐₓ, in order to correct the number of frames of the fraction, a BP-length above the standard BP-length N is divisionally set into a plurality of BPs so that each BP-length is below the maximum BP-length. Accordingly, the number of frames of the fraction is compensated without a BP shorter than the standard BP-length, and fall of encoding efficiency does not occur. Furthermore, a BP longer than the maximum BP-length does not generate, and functionality of random-access and trick play does not fall.

FIG. 29 is a flow chart to realize the fourth control method of BP-length. In the fourth control method, in order to compensate a number of frames of a fraction with a plurality of BPs in each segment, the most suitable location of a correction BP is collectively determined at a head of a segment. At start of BP-division control (S300), the frame is decided to be a head frame in the segment (S301). In case of the head frame, BP-component in the segment is collectively determined, a number of frames comprising i-th BP is set to “RemNumPicBp[i]”, and “0” is set to a BP-counter “bpnum” in the segment. In case of collectively setting BP-component, first, a number of frames of a fraction in the segment is calculated. If a sum of the fraction and a standard BP-length N is below a maximum BP-length Nₘₐₓ, any one of all BPs in the segment except for the last BP is set as BP-length of the sum.

If the sum is above the maximum BP-length Nₘₐₓ, first, any one of all BPs in the segment except for the last BP is set as the maximum BP-length, and a number of frames of a fraction is calculated. Furthermore, If a sum of the fraction and a standard BP-length N is above the maximum BP-length Nₘₐₓ, any one of all BPs in the segment except for the last BP and the above correction BP is set as the maximum BP-length. If the sum is below the maximum BP-length Nₘₐₓ, any one of all BPs in the segment except for the last BP and the above correction BP is set as BP-length of the sum. In this way, a correction BP is repeatedly added until the number of frames of the fraction is eliminated.

Above-mentioned processing is collectively executed at the head of the segment (S302), and each frame of BP is encoded in order of the BP component RemNumPicBp[i]. During encoding a BP of bpnum-th order, RemNumPicBp[bpnum] is decremented by “1” whenever one frame is encoded (S305). When RemNumPicBp[bpnum] is “0” (Yes at S303), “1” is added to bpnum (S304), and encoding of next BP starts.

By controlling as mentioned-above, as shown in FIG. 28, each BP having length above the standard BP-length N and below the maximum BP-length Nₘₐₓ is encoded irrespective of the number of frames of the fraction. As a result, while maintaining functionality of random-access and trick play, the number of frames of the fraction is compensated without fall of encoding efficiency.

### The Second Embodiment

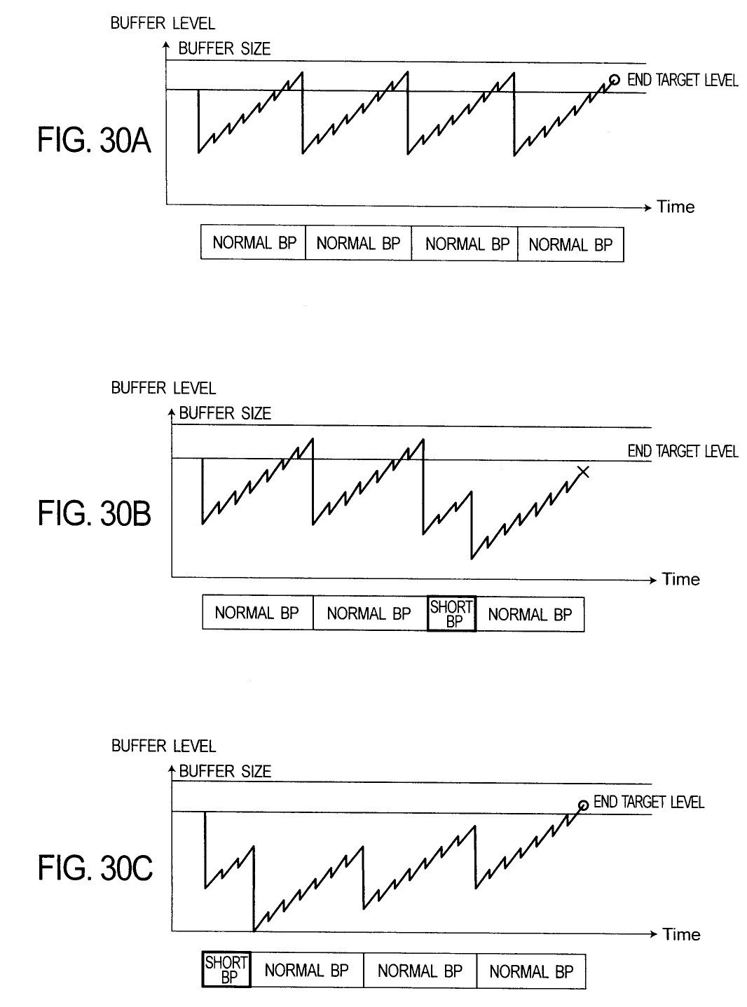

Next, the second embodiment of the present invention is explained by referring to FIGS. 30-34. The second embodiment directs to an optimization method to locate BP in relation to occupancy of a virtual (receiving) buffer model.

[1] The First Optimization Method:

First, the first optimization method is explained. FIGS. 30A, 30B and 30C show relationship between BP-location in a segment and variation of occupancy of the virtual (receiving) buffer model. The “virtual receiving buffer model” is a model of a receiving buffer at a decoder side, and it is necessary to encode each BP so that this model does not overflow and underflow. Furthermore, in case of divisionally encoding each segment, in order to guarantee seamless playback of connected encoded data (divisionally generated), continuity of the virtual buffer model need be guaranteed.

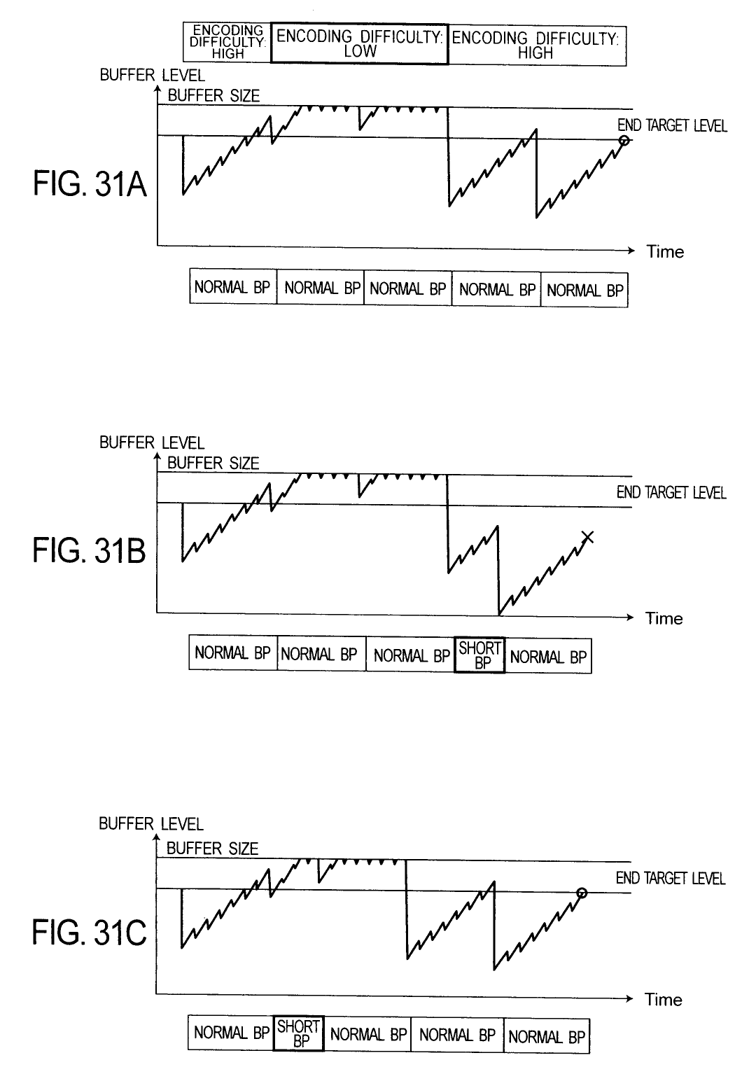

In the second embodiment, the case of a variable bit rate model in VBV (Video Buffering Verifier) model regulated by MPEG-2 video standard is explained. Furthermore, in the second embodiment, each BP corresponds to GOP structure in FIG. 5, and a first picture to encode in BP is I picture. As mentioned-above, a large number of encoded bits generates from I picture. Usually, in VBV buffer model, an occupancy of the virtual buffer suddenly falls at a head picture (I picture) of BP, and the occupancy gradually rises at P picture and B picture following from I picture. FIG. 31A shows this variation of the occupancy of the virtual buffer.

In order to guarantee continuity between two segments, for example, a target buffer level is determined, and an occupancy of VBV buffer at a start point of each segment is set to the target buffer level. In this case, if the occupancy of VBV buffer at an end point of each segment is above the target buffer level, encoded data of each segment can be connected without failure of the VBV buffer.

In the VBV model having variable bit rate regulated by MPEG-2, overflow of encoded bits (received in the virtual buffer) does not occur, and underflow is only prohibited. When the occupancy of VBV buffer at the end point of each segment is above the target buffer level, even if encoded data of each segment is connected, the occupancy of VBV buffer does not fall. Accordingly, underflow does not occur.

In the VBV model having constant bit rate regulated by MPEG-2, overflow and underflow are prohibited. When the occupancy of VBV buffer at the end point of each segment is above the target buffer level, by inserting stuffing data into a connection point between two segments, perfect seamless connection is possible.

FIG. 30B shows example that a second end BP-length in a segment is shortened in order to compensate a number of frames of a fraction in the segment. If BP-length is shortened, before fall of the occupancy of VBV buffer (because of I picture) sufficiently recovers, encoded bits of I picture of next BP are received. Accordingly, in order to decode I picture of next BP, the occupancy of VBV buffer shifts toward underflow direction. When the occupancy of VBV buffer falls near the end point of the segment, it is difficult to recover the occupancy above the target buffer level till the end point of the segment. In this case, connection of encoded data of each segment without failure of VBV cannot be guaranteed.

Furthermore, by compulsorily suppressing encoded bits (used for decoding) near the end point of the segment, the occupancy of VBV buffer can be quickly recovered. However, in this case, quality of decoded picture falls because of suppress of encoded bits used for decoding.

On the other hand, in the second embodiment, as shown in FIG. 30C, if a short BP is necessary to compensate a number of frames of a fraction, the short BP is located at a head of the segment. In this case, the occupancy of VBV buffer fallen (because of decoding the short BP) can be gradually recovered by encoding other BPs remained in the segment. As a result, without fall of the quality of encoded picture, the occupancy of VBV buffer at the end point of the segment can be controlled to be above the target buffer level. Accordingly, connectivity of encoded data between each segment can be stably guaranteed.

[2] The Second Optimization Method:

Next, in the second embodiment, the second optimization method to locate BP in relation to occupancy of the virtual buffer model is explained. In the same way as FIGS. 30A˜30C, FIGS. 31A, 31B and 31C show relationship between BP-length control and variation of the occupancy of the virtual buffer in VBV model having variable bit rate.

FIG. 31A shows an encoding difficulty in correspondence with the occupancy of the virtual buffer. As to the variable bit rate encoding, encoded bits are suppressed to encode a BP having low encoding difficulty, and encoded bits are increased to encode a BP having high encoding difficulty. As a result, stable picture quality is obtained with lower average encoded bits. According to VBV model of MPEG-2, an occupancy of virtual buffer rises at a frame of which encoded bits are suppressed, and the occupancy is saturated with a size of VBV buffer. Furthermore, the occupancy falls at a frame of which encoded bits are increased, and danger of VBV underflow also increases.

FIG. 31A shows an example that each BP is stably encoded without controlling BP-length. However, as shown in FIG. 31B, when BP-length of a second end BP in the segment (having the same video material) is controlled to be short, the occupancy of VBV buffer is not above the target level at the end of the segment in the same way as FIG. 30B. As a result, temporal-adjacent segments cannot be seamlessly connected.

On the other hand, as shown in FIG. 31C, a short BP-length to compensate frames of a fraction is allocated to a BP having low encoding difficulty and high occupancy of VBV buffer. As a result, the occupancy of VBV buffer can be stable controlled to be above the target level at the end of the segment.

As mentioned-above, in case of low encoding difficulty, the occupancy of VBV buffer generally rises. Accordingly, by previously detecting the encoding difficulty, optimal BP-allocation can be set. Furthermore, by previously estimating the occupancy of VBV buffer, the optimal BP-allocation can be also set. This determination of the optimal BP-allocation can be easily realized using two pass encoding method.

[3] Two Pass Encoding Method:

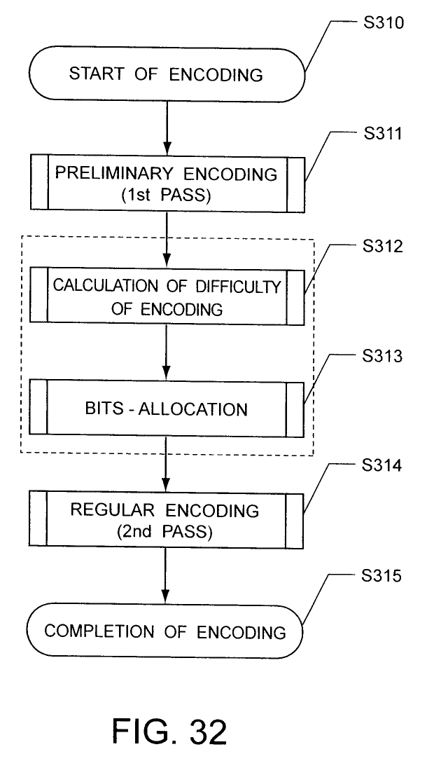

Next, two pass encoding method related with the second embodiment is explained. FIG. 32 is a flow chart of two pass variable bit rate encoding method of prior art. Concretely, in order to optimally allocate bits, a motion picture signal (preserved in a recording medium such as a VTR or a hard-disk drive) is encoded two times as a preliminary encoding and a regular encoding. For example, the two pass variable bit rate encoding method can be realized by a method described in JP No. 3734286.

In the two pass variable bit rate encoding method, first, all motion picture sequence is preliminarily encoded (S311). From statistic data such as encoded bits generated at that time, an encoding difficulty of each frame (or each scene) is calculated (S312). Based on the encoding difficulty, encoded bits are allocated (bits-allocation) to each frame (or each scene) of all motion picture sequence (S313). Based on the encoded bits allocated, all motion picture sequence is regularly encoded (S314).

[4] Optimal BP-Allocation Method:

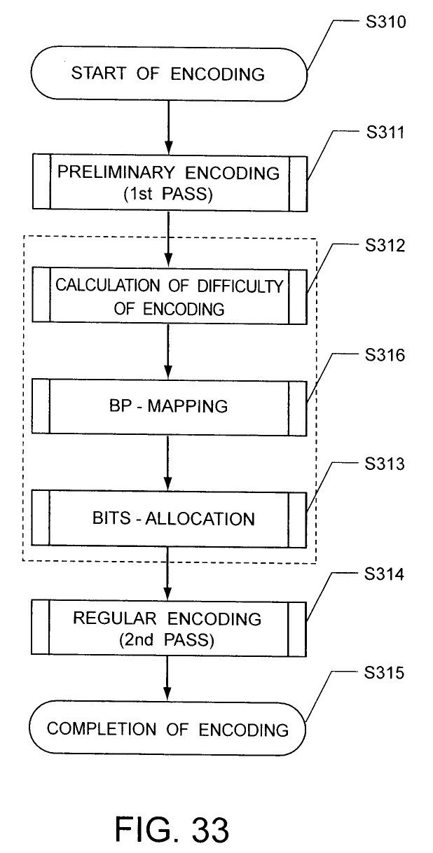

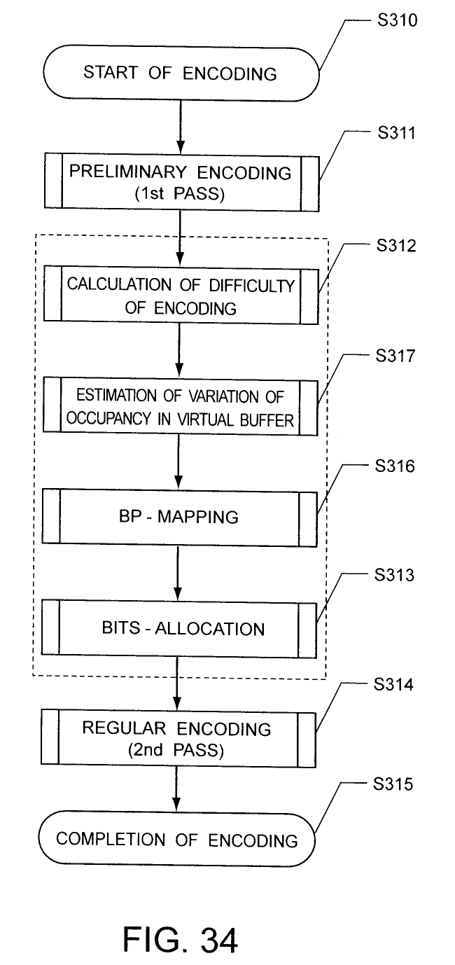

Next, by referring to FIGS. 33 and 34, optimal BP-allocation method according to the second embodiment in FIG. 31C is explained. In FIG. 33, after the encoding difficulty is calculated in two pass encoding of FIG. 32 (S312), BP-mapping processing (S316) to determine bits-allocation in a segment or all motion picture sequence is added. In the BP-mapping processing, in case of necessary a short BP (having short BP-length) to compensate frames of a fraction, the short BP is mapped onto a BP-position (in the segment) having low encoding difficulty calculated at S312. Then, by using processing result of bits-allocation (S313) and BP-mapping (S316), each BP in the segment is regularly encoded (S314). As a result, the segment can be encoded with optimal bits-allocation and optimal bits-allocation.

FIG. 34 is a flow chart of modification of FIG. 33. In FIG. 34, based on calculation result of the encoding difficulty (S312), temporal-variation of the occupancy of VBV buffer is estimated (S317). In case of necessary a short BP to compensate frames of a fraction, in BP-mapping processing (S316), the short BP is allocated at a BP-position having the highest occupancy of VBV buffer calculated at S317. As a result, in the same way as FIG. 33, the segment can be encoded with optimal bits-allocation and optimal bits-allocation.

[Modification]

The present embodiment is not limited to H.264. For example, the present embodiment may be applied to another motion picture encoding method having the same restriction as H.264.

In the disclosed embodiments, the processing can be accomplished by a computer-executable program, and this program can be realized in a computer-readable memory device.

In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An apparatus for encoding a motion picture, comprising:
a first division unit configured to divide the motion picture into a plurality of segments;
a second division unit configured to divide each segment into a plurality of picture groups each including a plurality of frames, the last picture group of each segment including frames of a fixed predetermined number;
an encoder configured to determine timing information of decoding and display of each picture group based on timing information of a head frame of a previous picture group in each segment, and to generate encoded data of each segment, the encoded data including the timing information of each picture group; and
a connection unit configured to connect the encoded data of the plurality of segments.

2. The apparatus according to claim 1,
wherein, if a total number of frames of a segment has a fraction below the predetermined number,
the second division unit adds the fraction to a number of frames of at least one picture group among the plurality of picture groups except for the last picture group in the segment.

3. The apparatus according to claim 1,
wherein, if a total number of frames of a segment has a fraction below the predetermined number,
the second division unit adds a new picture group including frames of the fraction to before or after at least one picture group among the plurality of picture groups except for the last picture group in the segment.

4. The apparatus according to claim 1,
wherein the motion picture is a picture signal displayed by 3:2 pull-down, and
wherein the second division unit divides each segment into a plurality of picture groups in which a display field of frames of the last picture group is a predetermined phase.

5. The apparatus according to claim 1,
further comprising a detection unit configured to detect a scene change point of the motion picture.

6. The apparatus according to claim 5,
wherein the first division unit divides the motion picture into a plurality of segments based on the scene change point, and
wherein the second division unit divides the segments into a plurality of picture groups based on the scene change point.

7. The apparatus according to claim 1,
further comprising a set unit to set a random access point to the motion picture.

8. The apparatus according to claim 7,
wherein the first division unit divides the motion picture into a plurality of segments based on the random access point, and
wherein the second division unit divides the segments into a plurality of picture groups based on the random access point.

9. The apparatus according to claim 1,
wherein the motion picture includes a plurality of motion picture signals representing a multi-story, each motion picture signal corresponding to a different segment, and
wherein the last picture group is a branch point to the plurality of motion picture signals, or a connection point to a next segment from the plurality of motion picture signals in the motion picture.

10. The apparatus according to claim 2,
wherein the second division unit compares a sum of the fraction and the predetermined number to a threshold, and, if the sum is below the threshold, adds the fraction to a number of frames of at least one picture group among the plurality of picture groups except for the last picture group in the segment.

11. The apparatus according to claim 3,
wherein the second division unit compares a sum of the fraction and the predetermined number to a threshold, and, if the sum is not below the threshold, adds the new picture group including frames of the fraction to before or after at least one picture group among the plurality of picture groups except for the last picture group in the segment.

12. The apparatus according to claims 2 and 3,
wherein the second division unit compares a sum of the fraction and the predetermined number to a threshold, and, if the sum is not below the threshold, divisionally adds frames of the fraction to at least two picture groups among the plurality of picture groups except for the last picture group in the segment so that a number of frames of each of the at least two picture groups is not above the predetermined number.

13. The apparatus according to claim 3,
wherein the second division unit adds the new picture group including frames of the fraction to the head picture group among the plurality of picture groups in the segment.

14. The apparatus according to claim 3,
further comprising a difficulty calculation unit configured to calculate an encoding difficulty representing difficulty to encode the motion picture; and
wherein the second division unit adds the new picture group including frames of the fraction to a temporal region where the encoding difficulty is lowest in the segment except for the last picture group in the segment.

15. The apparatus according to claim 3,
further comprising an estimation unit configured to estimate an occupancy estimated value representing temporal-variation of occupancy in a virtual buffer to receive an encoded motion picture; and
wherein the second division unit adds the new picture group including frames of the fraction to a temporal region where the encoding difficulty is lowest in the segment except for the last picture group in the segment.

16. The apparatus according to claim 1,
further comprising a plurality of encoders configured to respectively encode each of the plurality of segments in parallel.

17. A method for encoding a motion picture, comprising:
dividing the motion picture into a plurality of segments;
dividing each segment into a plurality of picture groups each including a plurality of frames, the last picture group of each segment including frames of a fixed predetermined number;
determining timing information of decoding and display of each picture group based on timing information of a head frame of a previous picture group in each segment;
generating encoded data of each segment, the encoded data including the timing information of each picture group; and
connecting the encoded data of the plurality of segments.

18. A computer readable medium storing program codes for causing a computer to encode a motion picture, the program codes comprising:
a first program code to divide the motion picture into a plurality of segments;
a second program code to divide each segment into a plurality of picture groups each including a plurality of frames, the last picture group of each segment including frames of a fixed predetermined number;
a third program code to determine timing information of decoding and display of each picture group based on timing information of a head frame of a previous picture group in each segment;
a fourth program code to generate encoded data of each segment, the encoded data including the timing information of each picture group; and
a fifth program code to connect the encoded data of the plurality of segments.
